(19) United States
(12) Patent Application Publication
(10) Pub. No.: US 2015/0169379 A1
(43) Pub. Date: Jun. 18, 2015

(54) INFORMATION PROCESSING METHOD, INFORMATION PROCESSING DEVICE, AND RECORDING MEDIUM

(71) Applicant: FUJITSU LIMITED, Kawasaki-shi (JP)

(72) Inventors: Satoshi MUNAKATA, Kawasaki (JP); Naoto TAKAHASHI, Kawasaki (JP); Kuniharu TAKAYAMA, Tama (JP)

(73) Assignee: FUJITSU LIMITED, Kawasaki-shi (JP)

(21) Appl. No.: 14/547,465

(22) Filed: Nov. 19, 2014

(30) Foreign Application Priority Data
Dec. 13, 2013 (JP) 2013-257896

(51) Int. Cl. G06F 9/50

(52) U.S. Cl. CPC G06F 9/5083

(57) ABSTRACT

An information processing method that is executed by a processor included in an information processing device, the information processing method includes obtaining request histories that respectively correspond to a plurality of operations, each of the plurality of operations including a plurality of works and each of the plurality of operations being executed based on a work request; extracting one or more request side works related to a request side of each of the plurality of operations, from among the plurality of works, based on the request histories; and generating process definition indicating definition of formalization of a process included in the one or more request side works.

### CROSS-REFERENCE TO RELATED APPLICATION

This application is based upon and claims the benefit of priority of the prior Japanese Patent Application No. 2013-257896, filed on Dec. 13, 2013, the entire contents of which are incorporated herein by reference.

### FIELD

The embodiments discussed herein are related to an information processing method, an information processing device, and a recording medium.

### BACKGROUND

Processing is executed in which works that are executed on an operation are formalized as processes on a system so as to be classified and extracted, and an identical operation or a similar operation is executed and analyzed on the system by reusing the formalized processes. For example, a workflow system is known in which a flow of an operation is defined as formalized processes beforehand, and the processing proceeds in accordance with the defined processes. The workflow system is constructed by analyzing the operation, or reconstructed by addition of a process and by change of the content or order of the processes in accordance with a change in the operation.

A technology is known by which construction and reconstruction of a workflow system are easily performed, with a demand of complication of an operation and a demand of rapid analysis of an operation. For example, there is a technology by which new addition and update of an operation application or an operation database to and in a workflow system are easily performed. A technology is known by which a type of operation specification is generated, and development of a workflow system is supported using the generated type of the operation specification in order to promote reuse of an application program that is used in the workflow system. In addition, in order to allow a workflow to be reused, a technology is known by which, regarding a procedure that is difficult to be utilized, which is included in a workflow that indicates a series of procedures, an available procedure is searched for, and the procedure of the search result is associated with the workflow and registered to a database so as to be allowed to be reused. As related arts, for example, Japanese Laid-open Patent Publication No. 2000-207474, Japanese Laid-open Patent Publication No. 11-85880, Japanese Laid-open Patent Publication No. 2004-133742, and the like have been discussed.

### SUMMARY

According to an aspect of the invention, an information processing method that is executed by a processor included in an information processing device, the information processing method includes obtaining request histories that respectively correspond to a plurality of operations, each of the plurality of operations including a plurality of works and each of the plurality of operations being executed based on a work request; extracting one or more request side works related to a request side of each of the plurality of operations, from among the plurality of works, based on the request histories; and generating process definition indicating definition of formalization of a process included in the one or more request side works.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of an operation formalization device according to an embodiment;

FIG. 2 is a block diagram illustrating an example of a computer system;

FIG. 3 is a block diagram illustrating an example in which the computer system is functionally represented;

FIG. 4 is an image diagram illustrating an example of a work request history database;

FIG. 5 is an image diagram illustrating an example of an operation service database;

FIG. 6 is an image diagram illustrating an example of an operation domain database;

FIG. 7 is an image diagram illustrating an example of a distribution rule database;

FIG. 8 is an image diagram illustrating an example of a work item database;

FIG. 9 is an image diagram illustrating an example of a process definition database;

FIG. 10 is an image diagram illustrating an example of a work item definition database;

FIG. 11 is a flowchart illustrating an example of the overall flow of processing in which an operation is effected;

Each of FIGS. 12A and 12B is a part of a sequence flow illustrating an example of a relationship between units in operation effect processing;

Each of FIGS. 13A and 13B is a part of the sequence flow illustrating the example of the relationship between the units in the operation effect processing;

FIG. 14 is a part of the sequence flow illustrating the example of the relationship between the units in the operation effect processing;

FIG. 15 is a part of the sequence flow illustrating the example of the relationship between the units in the operation effect processing;

FIG. 16 is an image diagram illustrating an example of a display screen of an operation effect list;

FIG. 17 is an image diagram illustrating an example of a work effect screen;

FIG. 18 is a flowchart illustrating an example of a flow of effect processing of a work item;

FIG. 19 is a sequence flow illustrating an example of a relationship between the units in the effect processing of the work item;

FIG. 20 is a flowchart illustrating an example of work request processing;

Each of FIGS. 21A and 21B is a sequence flow illustrating an example of a relationship between the units in the work request processing;

FIG. 22 is a diagram illustrating utilization of operation service;

FIG. 23 is a diagram illustrating a request to an operation domain;

FIG. 24 is a flowchart illustrating an example of a flow of suggestion processing of operation service;

Each of FIGS. 25A and 25B is a part of a sequence flow illustrating an example of a relationship between the units in the suggestion processing of the operation service;

Each of FIG. 26A and FIG. 26B is a part of the sequence flow illustrating the example of the relationship between the units in the suggestion processing of the operation service;

FIG. 27 is a diagram illustrating an example of operation service identification in the suggestion processing of the operation service;

FIG. 28 is a diagram illustrating an example of operation service setting in the suggestion processing of the operation service;

FIG. 29 is a diagram illustrating an example of a flow of information that is related to suggestion of the operation service;

FIG. 30 is a diagram illustrating an example of a flow of information that is related to integration of the operation service; and

FIG. 31 is a diagram illustrating an example of a flow of continual processing of a computer system.

### DESCRIPTION OF EMBODIMENTS

In an operation, there is a case in which cooperation of an expert who has an advanced skill is desired for a certain work that is performed on the operation. In this case, there is a flow of the operation, in which a requester requests a certain work from an expert, and the expert receives and effects the requested work. In addition, the content of the operation may be considered from both views of the request side who requests the work and the reception side who receives the request of the work and effects the work. Thus, process definition may be reused by considering the work contents of the request side and the reception side and formalizing the operation.

When the operation is formalized by considering the both contents of the works of the request side and the reception side, the reproducibility of the operation is improved. However, the pieces of process definition become large and complicated, so that enormous burden is desired for maintenance after the operation is formalized. For example, when the work content of the reception side is considered on the request side, there is a trade-off relationship between improvement of the reception rate of work requests and reduction in maintainability due to the enormous process definition. On the other hand, when the work content is considered on the reception side, and addition of process definition is performed, pieces of process definition of similar work contents are increased, so that the burden of the maintenance is increased. In addition, when a work content is different for each expert who effects a work on the reception side, process definition of formalization that is used for distribution to each of the experts, or different process definition for each of the experts is generated, so that the burden of the maintenance is increased. In the operation that is formalized for each of the experts, an individual work becomes fixed, and the versatility becomes poor, so that it is also probable that the process definition may not be reused.

Therefore, a method is conceived in which an operation is formalized using a technology by which an operation application and an operation database are newly added to the workflow or updated in the workflow. However, even when the operation application and an operation database are newly added to the workflow or updated in the workflow, it is probable that the both contents of the works of the request side and the reception side are not considered. The workflow is increased for each type of works, so that the burden of the maintenance is increased. Thus, even when the operation application and the operation database are newly added to the workflow or updated in the workflow, it is probable that process definition obtained by formalizing the operation may not be reutilized.

In the technology in which the generated type of the operation specification is used, there is case in which the both contents of the works of the request side and the reception side are not considered. Thus, even when the type of the operation specification is used, it is probable that the process definition that is obtained by formalizing the operation may not be reutilized.

In addition, in the technology by which the procedure that is obtained by the search result regarding the procedure that is difficult to be utilized, which is included in the workflow, is associated with the workflow and registered to the database so as to be allowed to be reused, it is probable that the both contents of the works of the request side and the reception side are not considered. Thus, even when the procedure that is obtained by the search result regarding the procedure that is difficult to be utilized, which is included in the workflow, is associated with the workflow and registered to the database so as to be allowed to be reused, there is case in which process definition that is obtained by formalizing the operation may not be reused.

Examples of embodiments of the technology discussed herein are described in detail below with reference to drawings.

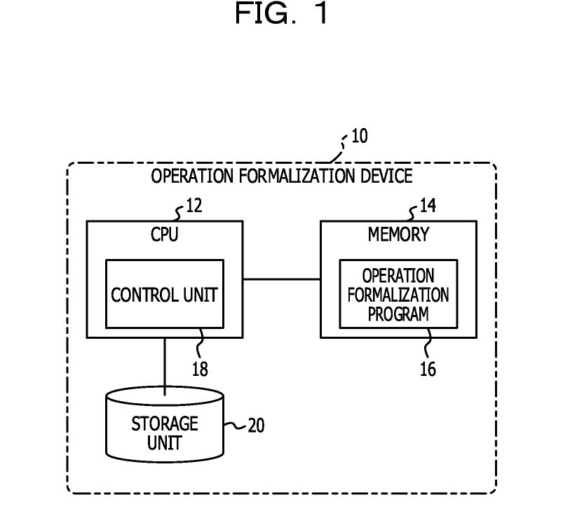

FIG. 1 illustrates an example of an operation formalization device according to an embodiment. An operation formalization device 10 is an information processing device which includes a central processing unit (CPU) 12 and a memory 14. In the memory 14, an operation formalization program 16 is stored. In the operation formalization device 10, the CPU 12 operates as a control unit 18 when the CPU 12 executes the operation formalization program 16. The operation formalization device 10 includes a non-volatile storage unit 20. In the storage unit 20, pieces of information that respectively indicate a request history of a work, process definition, and operation service are stored.

The control unit 18 of the operation formalization device 10 extracts a plurality of work groups, and operation service that indicates the content of the operation and defines a relationship between the plurality of work groups, from the operation, based on request histories of works included in operations that are stored in the storage unit 20. For example, in the operation, the plurality of work groups is classified into a work group that includes a work of the request side and a work group that includes a work of the reception side. The control unit 18 generates process definition that is obtained by formalizing the operation for each of the plurality of work groups. The process definition is information that is obtained by formalizing the operation for each of the work groups. The control unit 18 stores information that indicates the generated process definition and information that indicates the operation service in the storage unit 20 so that the pieces of information are allowed to be reused. In the embodiment, the work may be handled in a unit of an operation domain by a member who is related to the operation for each of the work groups.

The operation domain corresponds to information that indicates a generic name of an organization including a member who is related to the operation. The organization including the member may also be information that indicates one of a formal organization and an informal organization. The operation domain may be information that indicates an organization that does not include a member, which is used to perform addition of a member. In addition, the operation domain may make a relationship with a further operation domain based on information that indicates an ownership relationship with the further operation domain. A structure of an organization may be represented by a plurality of operation domains based on information that indicates an ownership relationship. For example, a responsible management party of an organization may be caused to correspond to an administrator of the operation domain when the administrator of the operation domain administrates the operation domain as the organization, and a member of the operation domain may be caused to correspond to the administrator of the operation domain when the member of the operation domain administrates a conduit.

The operation domain may function as a unit of the reception side, which receives a request of a work on the operation. That is, a requester may request the work by specifying an operation domain without specifying an effecter of the work. The operation domain may also function as a unit of the reception side, which takes on a work, rejects the work, or re-requests the work to another operation domain. For example, the operation domains may function as an interested party who receives a request of a work on the operation, and executes processing in which a member takes on a work, rejects the work, or re-requests the work to another operation domain, in accordance with a request distribution rule that has been defined beforehand. The request distribution rule indicates a condition that is used to identify a member who is included in the operation domain.

The operation service corresponds to a generic name of a conduit that requests a work to be taken on. For example, the operation service corresponds to information that indicates specification of a work to be taken on by a member who has been registered to the operation domain. An example of the specification of the work to be taken on includes information such as a purpose, input information, output information, and a deadline. The member who has been registered to the operation domain may search for operation service that the member desires to use by publishing the specification of the work to be taken on, to the member. The specification of the work to be taken on is created and published by the administrator of the operation domain. That is, the administrator of the operation domain may create operation service, and publish the operation service to the member who has been registered to the operation domain. Process definition that is used to effect the taken-on work and a request distribution rule are specified and associated with the operation service. A recipient of the operation service may distinguish management ranges of the process definition of the requester and the recipient by using and managing the associated process definition.

The operation formalization device 10 is an example of the operation formalization device in the technology discussed herein. The operation formalization program 16 is an example of the operation formalization program in the technology discussed herein. The control unit 18 according to the embodiment corresponds to the control unit in the technology discussed herein. The storage unit 20 corresponds to the storage unit in the technology discussed herein.

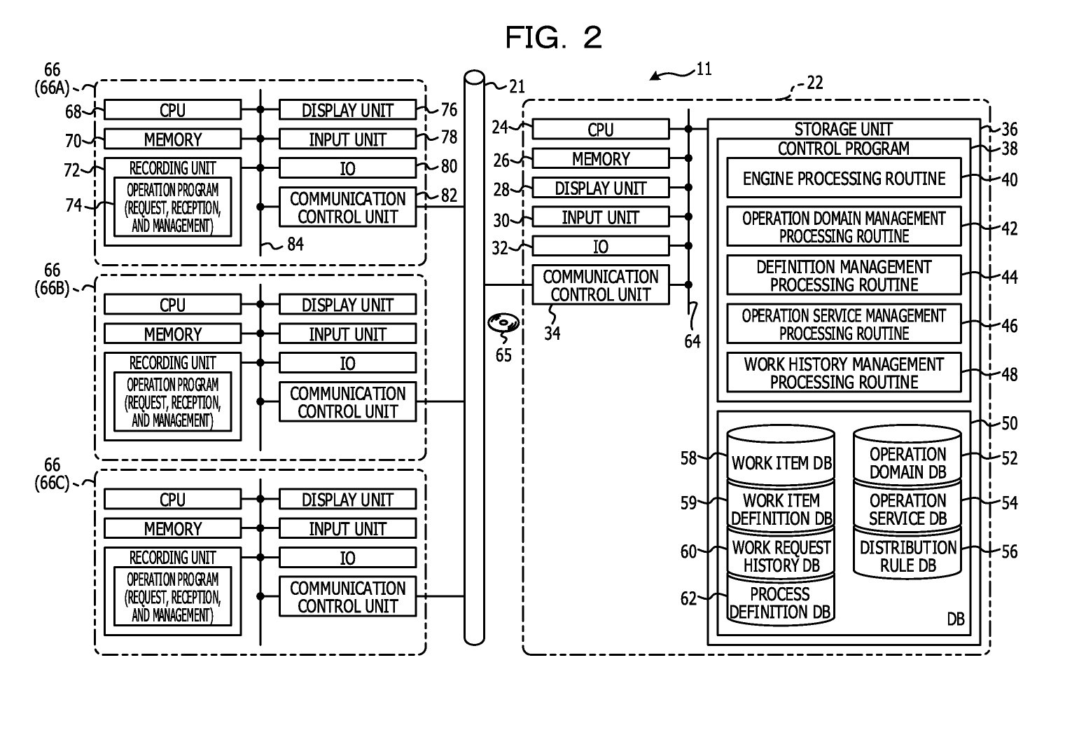

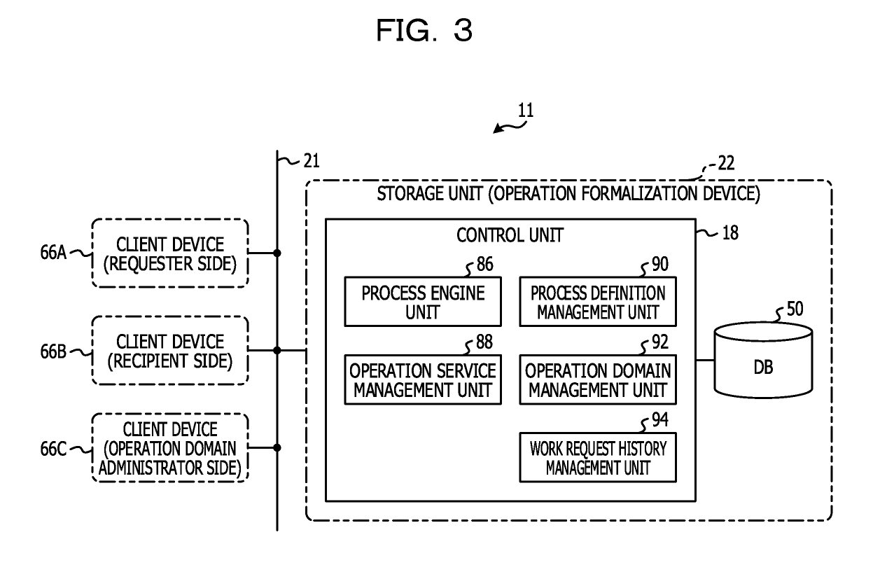

FIG. 2 illustrates a computer system 11 as an example of a system in which the operation formalization device 10 may be obtained by a computer. FIG. 3 illustrates an example in which the computer system 11 illustrated in FIG. 2 is represented by functional blocks. The computer system 11 illustrated in FIGS. 2 and 3 includes a server device 22 and a plurality of client devices 66. The operation formalization device 10 (FIG. 1) may be obtained by the server device 22.

The server device 22 includes a CPU 24, a memory 26, and a non-volatile storage unit 36. The CPU 24, the memory 26, and the storage unit 36 are connected to each other through a bus 64. The server device 22 includes a display unit 28 such as a display, and an input unit 30 such as a keyboard and a mouse. The display unit 28 and the input unit 30 are connected to the bus 64. In the server device 22, a device (IO device) 32 that performs read and write for an inserted recording medium 65 is connected to the bus 64. The storage unit 36 may be a hard disk drive (HDD), a flash memory, or the like. The server device 22 includes a communication control unit 34 that is an interface to a computer network 21. The communication control unit 34 is connected to the bus 64.

In the storage unit 36, a control program 38 as the operation formalization program 16, and a database (DB) 50 are stored. The control program 38 includes an engine processing routine 40, an operation domain management processing routine 42, a definition management processing routine 44, an operation service management processing routine 46, and a work history management processing routine 48. The server device 22 operates as the control unit 18 of the operation formalization device 10 (FIG. 1) when the CPU 24 reads the control program 38 from the storage unit 36, and deploys the read control program 38 to the memory 26, and executes each of the processing routines that are included in the control program 38.

The server device 22 operates as a process engine unit 86 illustrated in FIG. 3 when the CPU 24 executes the engine processing routine 40. The server device 22 operates as an operation domain management unit 92 illustrated in FIG. 3 when the CPU 24 executes the operation domain management processing routine 42. The server device 22 operates as a process definition management unit 90 illustrated in FIG. 3 when the CPU 24 executes the definition management processing routine 44. The server device 22 operates an operation service management unit 88 illustrated in FIG. 3 when the CPU 24 executes the operation service management processing routine 46. In addition, the server device 22 operates as a work request history management unit 94 illustrated in FIG. 3 when the CPU 24 executes the work history management processing routine 48.

The process engine unit 86 may perform execution processing of process definition, and management processing of a work state. The operation domain management unit 92 may perform registration processing of an operation domain, search processing of an operation domain, work request processing to an operation domain, and registration processing of a request distribution rule. The process definition management unit 90 may perform registration processing of process definition, and search processing of process definition. The operation service management unit 88 may perform registration processing of operation service, search processing of operation service, and utilization processing of operation service. The work request history management unit 94 may perform registration processing of a work request history, search processing of a work request history, suggestion processing of operation service publication, and suggestion processing of utilization of operation service.

In the database 50 that is stored in the storage unit 36, a work item database 58 including a work item definition database 59, and a work request history database 60 are stored. In the database 50, a process definition database 62, an operation domain database 52, an operation service database 54, and a distribution rule database 56 are also stored. Hereinafter, a database is referred to as “DB”.

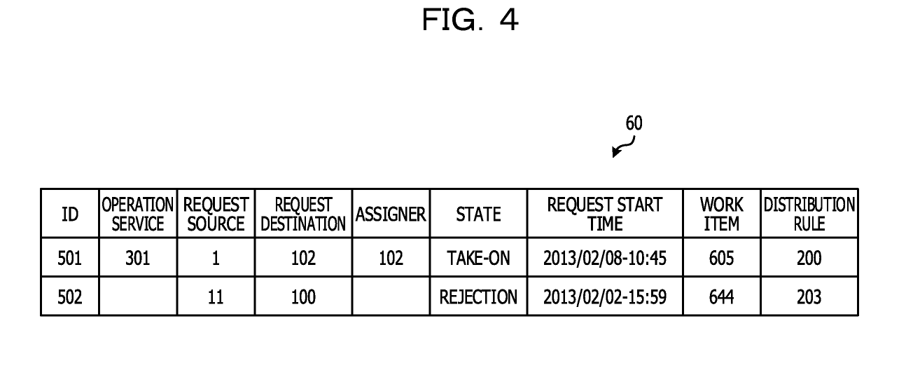

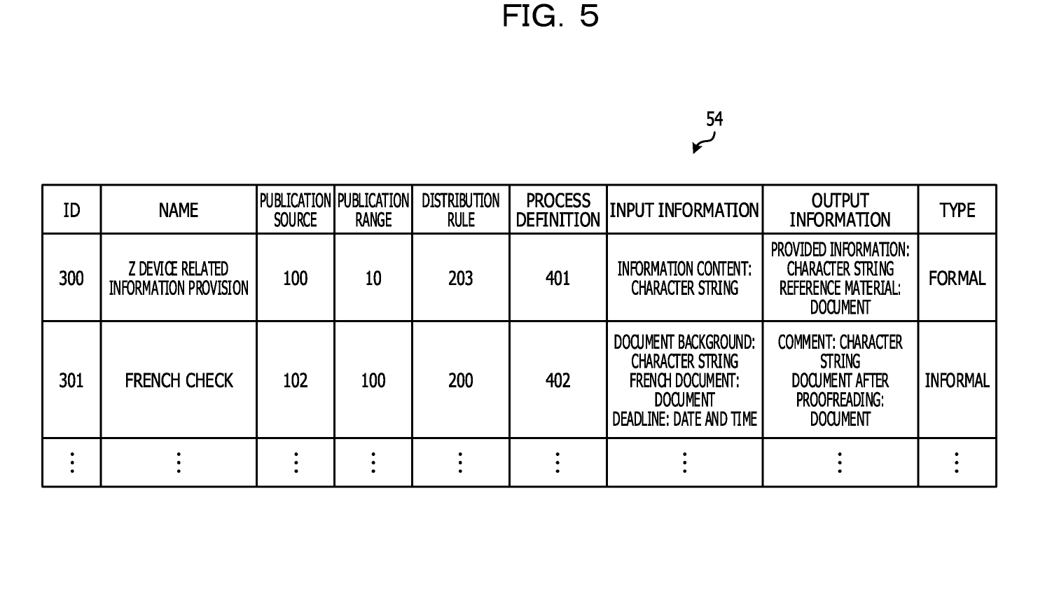

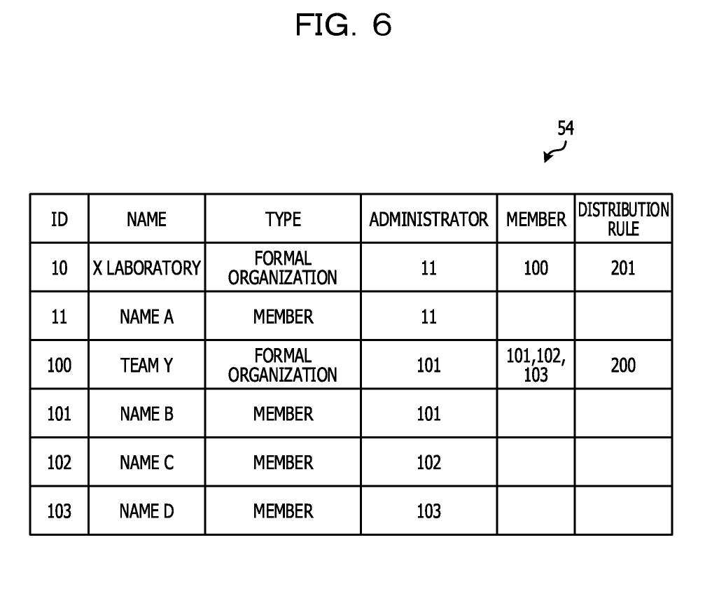

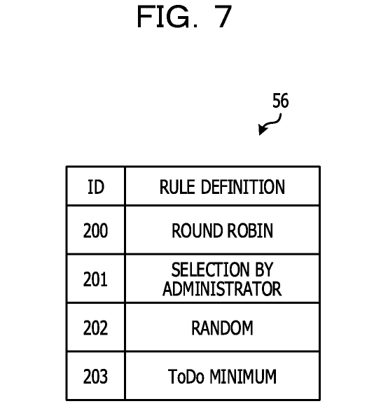

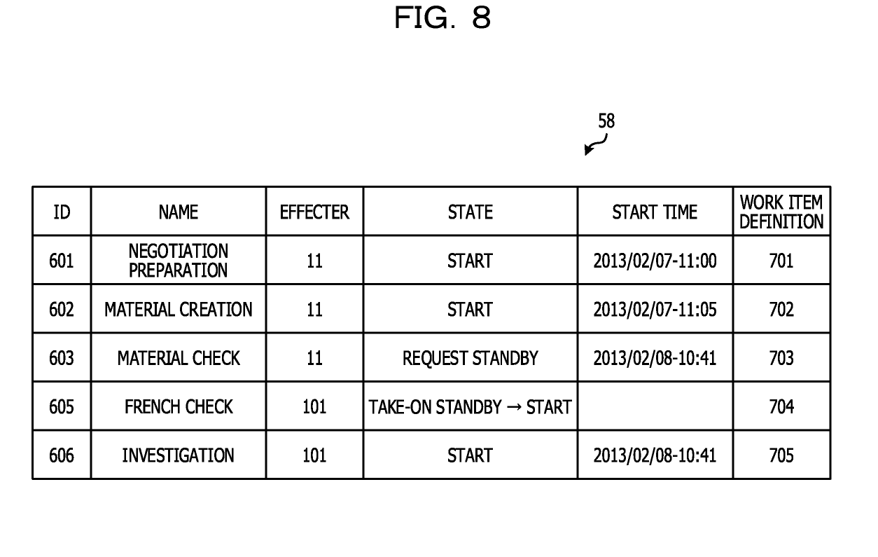

FIGS. 4 to 10 respectively illustrate examples of the various DBs that are stored in the DB 50. FIG. 4 illustrates an example of the work request history DB 60. To the work request history DB 60, pieces of information that indicate request histories of works that are related to an operation are registered. As illustrated in FIG. 4, to the work request history DB 60, for example, pieces of information on “ID”, “operation service”, “request source”, “request destination”, “assigner”, “state”, “request start time”, “work item”, and “distribution rule” are registered. To the information on “operation service”, an ID that is indicated in the operation service DB 54 (FIG. 5) is registered. To the pieces of information on “request source”, “request destination”, and “assigner”, IDs that are indicated in the operation domain DB 52 (FIG. 6) is registered. In addition, to the information on “work item”, an ID that is indicated in the work item DB 58 (FIG. 8) is registered. In addition, to the information on “distribution rule”, an ID that is indicated in the distribution rule DB 56 (FIG. 7) is registered.

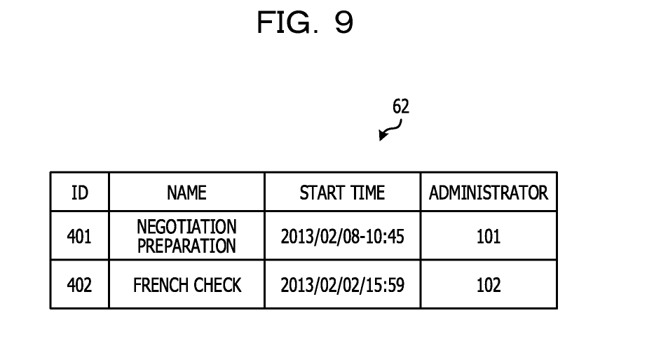

FIG. 5 illustrates an example of the operation service DB 54. To the operation service DB 54, pieces of information on pieces of operation service are registered. As illustrated in FIG. 5, to the operation service DB 54, for example, pieces of information on “ID”, “name”, “publication source”, “publication range”, “distribution rule”, “process definition”, “input information”, “output information”, and “type” are registered. To the pieces of information on “publication source” and “publication range”, the IDs that are indicated in the operation domain DB 52 (FIG. 6) are registered. To the information on “distribution rule”, the ID that is indicated in the distribution rule DB 56 (FIG. 7) is registered. In addition, to the information on “process definition”, an ID that is indicated in the process definition DB 62 (FIG. 9) is registered.

FIG. 6 illustrates an example of the operation domain DB 52. To the operation domain DB 52, pieces of information that are related to operation domains are registered. As illustrated in FIG. 6, to the operation domain DB 52, for example, pieces of information on “ID”, “name”, “type”, “administrator”, “member”, and “distribution rule” are registered. To the pieces of information on “administrator” and “member”, the IDs that are indicated in the operation domain DB 52 (FIG. 6) are registered. To the information on “distribution rule”, the ID that is indicated in the distribution rule DB 56 (FIG. 7).

FIG. 7 illustrates an example of the distribution rule DB 56. To the distribution rule DB 56, rules that are used when distribution processing is executed are registered. As illustrated in FIG. 7, to the distribution rule DB 56, for example, pieces of information on “ID” and “rule definition” are registered.

FIG. 8 illustrates an example of the work item DB 58. To the work item DB 58, pieces of information that indicate items of works are registered. As illustrated in FIG. 8, to the work item DB 58, for example, pieces of information on “ID”, “effecter”, “state”, “start times”, and “work item definition” are registered. To the information on “effecter”, the ID that is indicated in the operation domain DB 52 (FIG. 6) is registered.

FIG. 9 illustrates an example of the process definition DB 62. To the process definition DB 62, pieces of information that indicate pieces of process definition are registered. As illustrated in FIG. 9, to the process definition DB 62, for example, pieces of information on “ID”, “name”, “creation time”, and “administrator” are registered. To the information on “administrator”, the ID that is indicated in the operation domain DB 52 (FIG. 6) is registered.

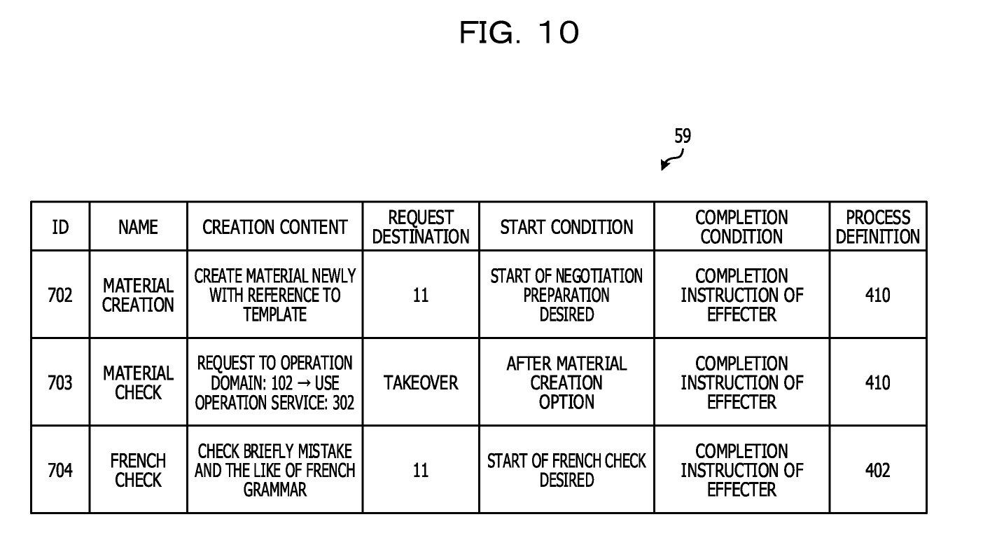

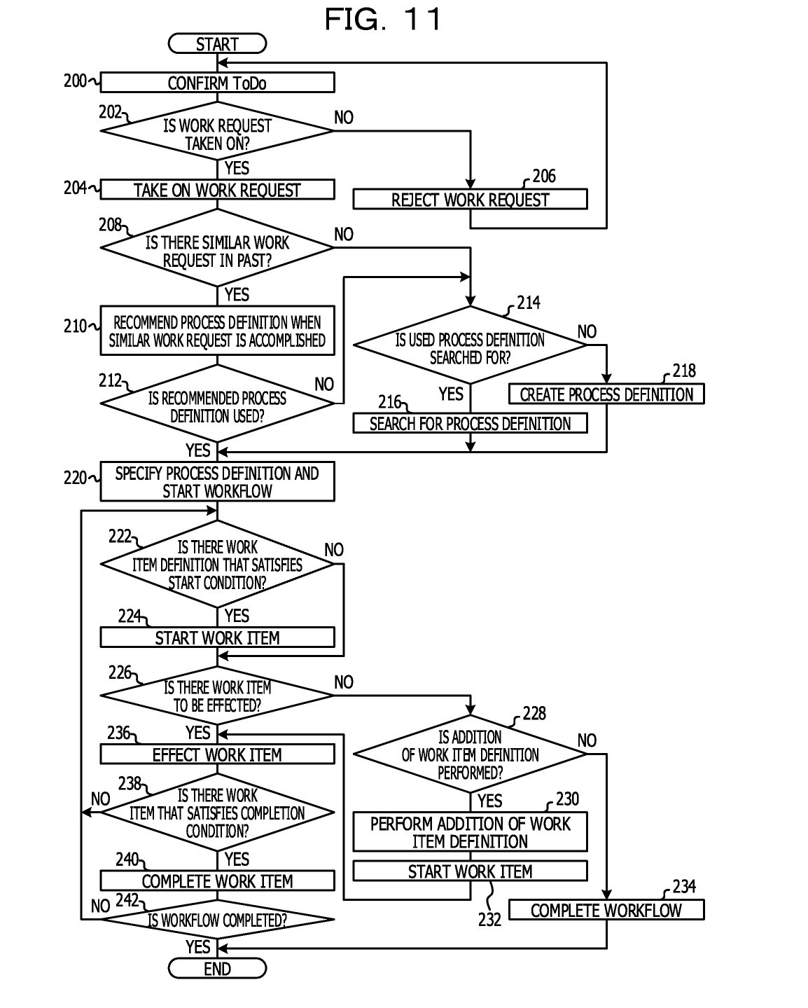

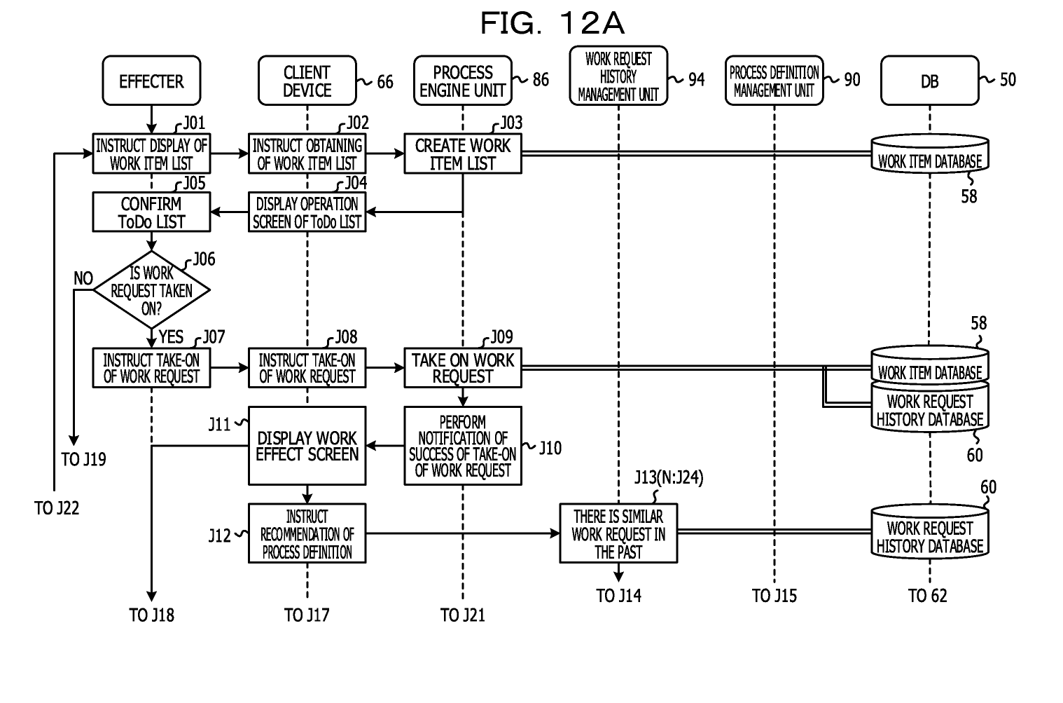

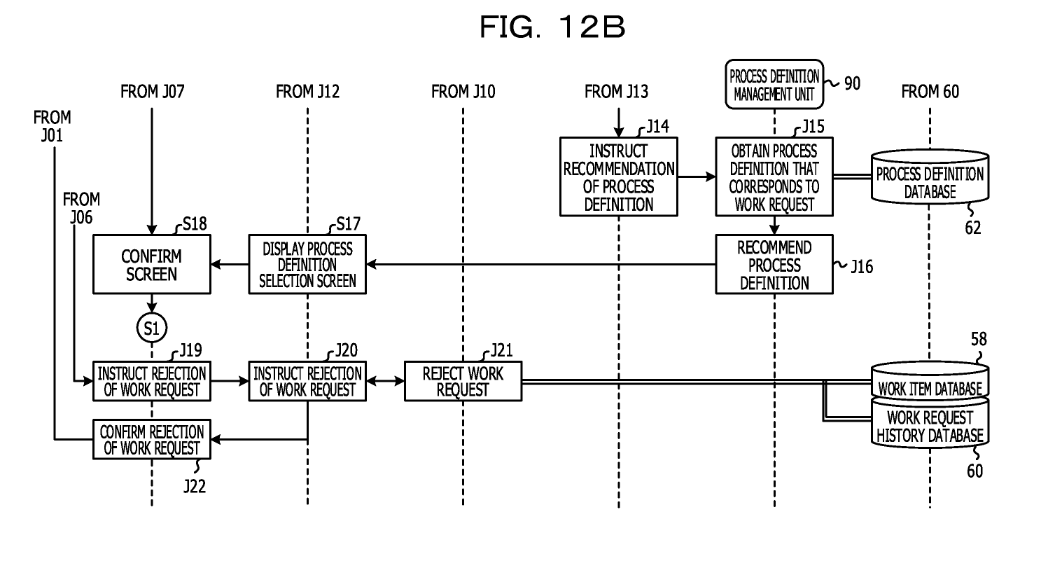

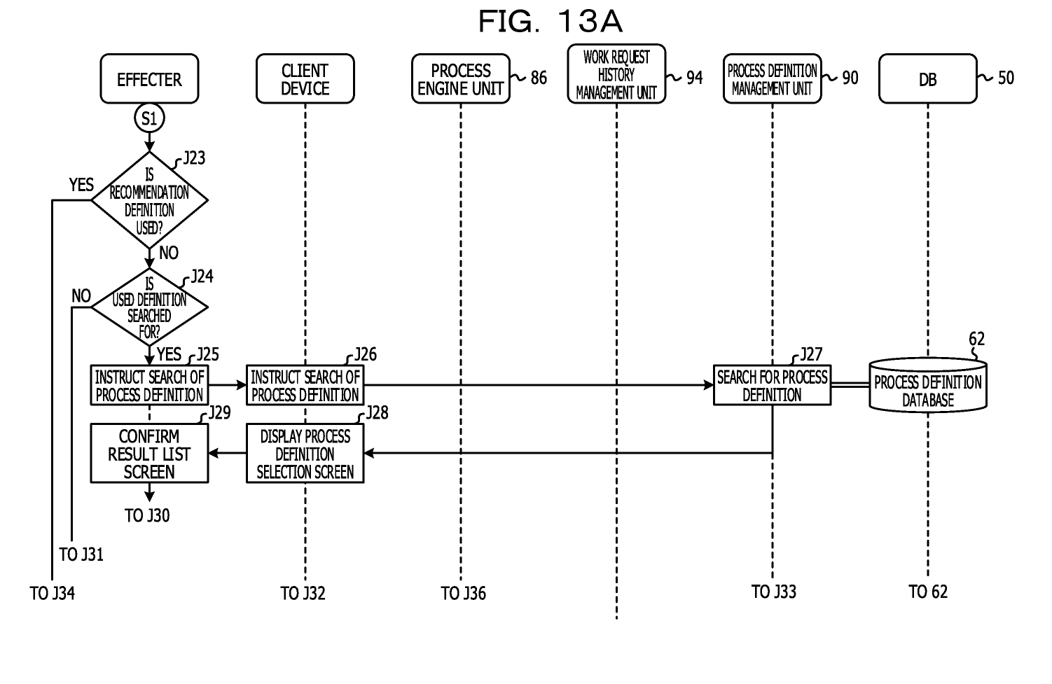

FIG. 10 illustrates an example of the work item definition DB 59. To the work item definition DB 59, pieces of information that respectively indicate pieces of definition of work items are registered. As illustrated in FIG. 10, to the work item definition DB 59, for example, pieces of information on “ID”, “name”, “creation content”, “request destination”, “start condition”, “completion condition”, and “process definition” are registered. Here, to the information on “request destination”, the ID that is indicated in the operation domain DB 52 (FIG. 6) is registered. To the information on “process definition”, the ID that is indicated in the process definition DB 62 (FIG. 9) is registered.

In the embodiment, a case is described in which the server device 22 operates as the process engine unit 86, the operation domain management unit 92, the process definition management unit 90, the operation service management unit 88, and the work request history management unit 94, but these units may be operated in a plurality of devices. For example, at least some of the process engine unit 86, the operation domain management unit 92, the process definition management unit 90, the operation service management unit 88, and the work request history management unit 94 may be operated in a further device.

Each client device 66 includes a CPU 68, a memory 70, and a recording unit 72. The CPU 68, the memory 70, and the recording unit 72 are connected to each other through a bus 84. Each of the client devices 66 includes a display unit 76 such as a display, and an input unit 78 such as a keyboard and a mouse. The display unit 76 and the input unit 78 are connected to the bus 84. In each of the client devices 66, a device (10 device) 80 that is used to perform read and write on the inserted recording medium 65 is connected to the bus 64. Each of the client devices 66 includes a communication control unit 82 that is used to be connected to the computer network 21. The communication control unit 82 is connected to the bus 84.

In the recording unit 72, an operation program 74 is stored. The operation program 74 includes processing routines that are related to a request, reception, and management, respectively. The client devices 66 are respectively operated by a requester of the operation, a recipient of the request, and an administrator of an operation domain. The client device 66 operates as a request device 66A illustrated in FIG. 3 when the CPU 68 reads the operation program 74 from the recording unit 72, deploys the read operation program 74 to the memory 70, and executes the processing routine that is related to the request, which is included in the operation program 74. The client device 66 operates as a reception device 66B illustrated in FIG. 3 when the CPU 68 executes the processing routine that is related to the reception, which is included in the operation program 74. In addition, the client device 66 operates as a management device 66C illustrated in FIG. 3 when the CPU 68 executes the processing routine that is related to the management, which is included in the operation program 74.

In the request device 66A, an operation is performed in processing of one of a request of a work, change in the work state, and edition of process definition. In the reception device 66B, an operation is performed in processing of one of reception of a work, change in the work state, and edition of process definition. In the management device 66C, an operation is performed in processing of one of registration of an operation domain and registration of operation service.

When each of the units in the client device 66 that operates as one of the request device 66A, the reception device 66B, and the management device 66C is distinguished, the description is made below so that one of symbols A, B, and C is respectively provided to the unit of the client device 66.

An operation of the embodiment is described below.

When an operation is formalized, it is desirable that a degree of consideration of a work for formalization, a degree of consideration of maintenance after formalization for the formalization, and a degree of formalization of a work in which points of views are different between the request side of operation and the reception side of the request of the operation are considered.

Therefore, in the embodiment, respective concerns between a requester and the recipient of the work are formalized so as to be separated from each other using operation service as a boundary. That is, for example, a member of the requester side empirically obtains information such as “when and what kind of work is requested”. In the embodiment, information that is empirically obtained on the requester side (so-called know-how, and the like) is formalized as “work item that utilizes operation service in the process definition”. A member of the recipient side also empirically obtains information such as “by who and how a request is effected”. In the embodiment, the information that is empirically obtained on the recipient side is formalized as “request distribution rule that is registered to operation service”. By formalizing the pieces of information that are empirically obtained on the requester side and the recipient side, the pieces of information of the requester side and the recipient side may be formalized so as to be separated from each other.

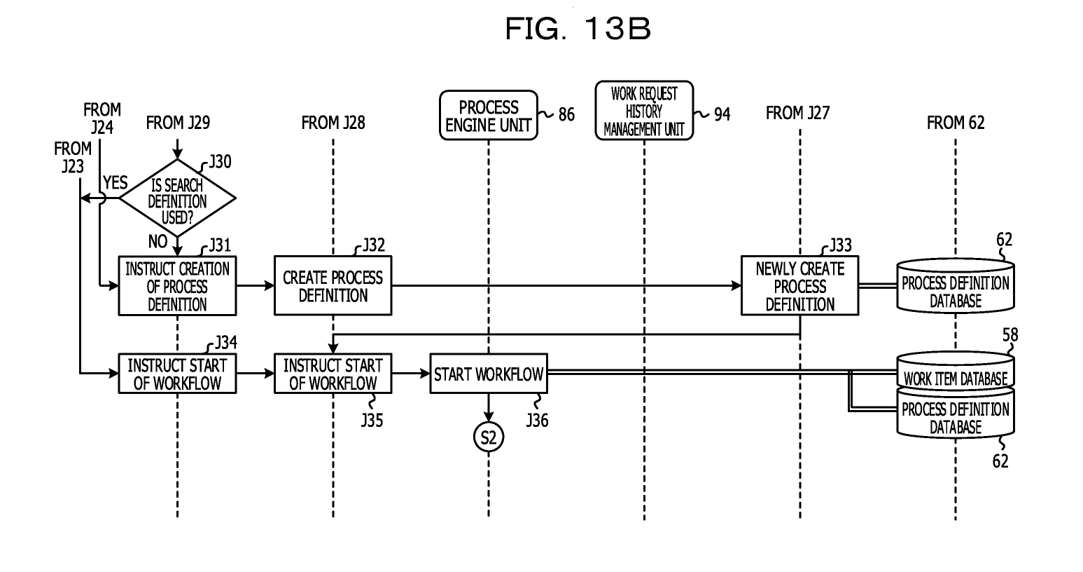

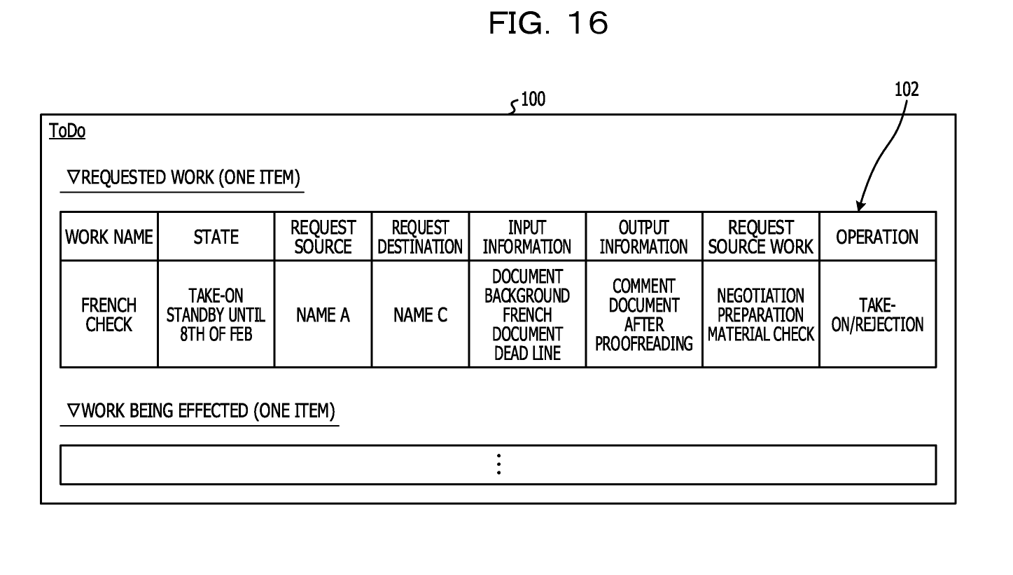

FIG. 11 illustrates an example of the overall flow of processing in which an operation is effected. In each of FIGS. 12A, 12B, 13A, 13B, 14 and 15, a relationship between the client device 66 and the units in the server device 22 is illustrated as a sequence flow. In the embodiment, a case is described in which an effecter effects the operation with reference to an operation effect list (so-called ToDo list) that is a list of operations and works that are candidates that are effected by the effecter. In FIG. 16, a ToDo screen 100 is illustrated as an example of a screen on which an operation effect list 102 is displayed.

In the computer system 11, the CPU 68 of the client device 66 executes the operation program 74, and the CPU 24 of the server device 22 executes the control program 38. First, in the computer system 11, in Step 200, confirmation processing of an operation that is related to an effecter who effects an operation is executed. That is, the effecter who effects the operation operates the client device 66 in order to confirm the operation that is related to the effecter (Process J01 illustrated in FIG. 12A). The client device 66 outputs information that is used to instruct the obtaining of a work item list, to the process engine unit 86, based on the information that has been input from the effecter (Process J02). The process engine unit 86 generates a work item list in accordance with the instruction from the client device 66, with reference to the work item DB 58, and transmits the generated work item list to the client device 66 (Process J03). The client device 66 generates an operation effect list using the work item list that has been transmitted from the process engine unit 86, and displays an operation screen of the operation effect list on the display unit 76 (Process J04). The effecter confirms the operation with reference to the display unit 76 (also see Process J05 and FIG. 16).

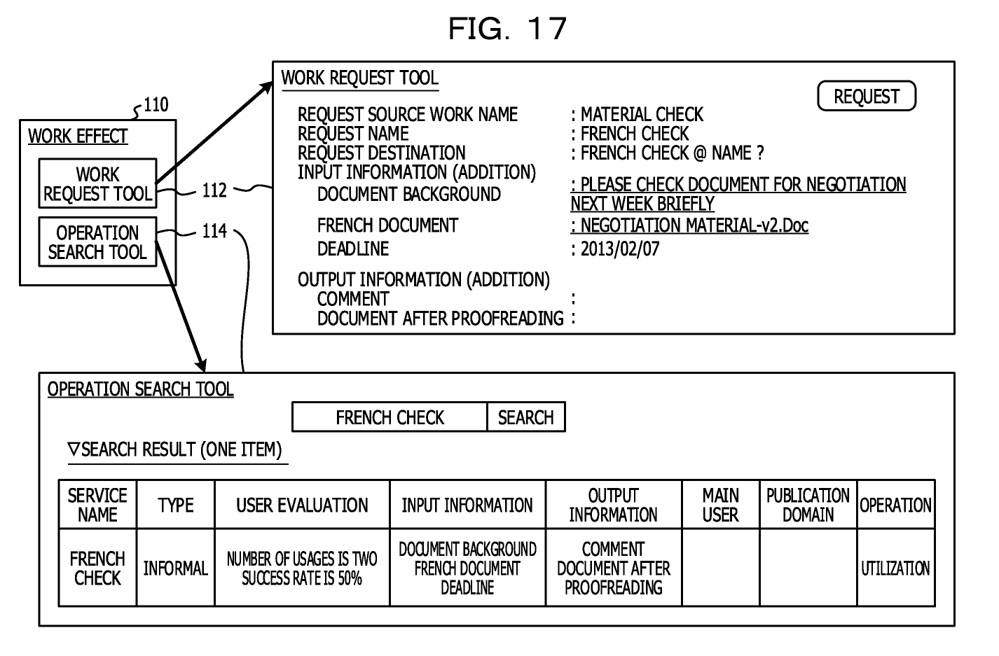

In Step 202, in the computer system 11, determination processing of whether or not a work request is taken on is executed. When “Yes” is determined in Step 202, take-on processing of the work request is executed in Step 204, and the processing proceeds to Step 208. That is, the effecter determines whether or not the work request is taken on, with reference to the operation screen of the operation effect list in the client device 66 (Process J06 illustrated in FIG. 12A), and operates the client device 66. When the client device 66 is operated in order to take on the work request (Process J07), the client device 66 outputs information that is used to instruct the take-on of the work request, to the process engine unit 86 (Process J08). The process engine unit 86 executes work request take-on processing using the work item DB 58 and the work request history DB 60, in accordance with the instruction from the client device 66 (Process J09). In addition, the process engine unit 86 transmits information that indicates that the work request take-on processing has been executed successfully, to the client device 66 (Process J10). The client device 66 changes the state in the work item of the operation effect list 102 in the ToDo screen 100, from “take-on standby” to “start”, and displays a work effect screen 110 on the display unit 76, based on the information that has been transmitted from the process engine unit 86 (Process ill). That is, in the client device 66, the screen transitions to the work effect screen 110 illustrated in FIG. 17. The effecter confirms the operation with reference to the display unit 76 (Process 318). As illustrated in FIG. 17, the work effect screen 110 includes a display area 112 of a work request tool, and a display area 114 of an operation search tool.

In Step 208, the computer system 11 executes determination processing of whether or not a similar work request exists in the past. When “Yes” is determined in Step 208, recommendation processing of process definition when the similar work request has been accomplished is executed in Step 210. The recommendation processing of the process definition is processing in which when a newly work request is executed for a certain operation domain, a work request having the highest degree of similarity is searched for, and process definition that has been used for the work request of the search result is recommended. That is, the client device 66 displays the work effect screen 110 (Process ill illustrated in FIG. 12A), and outputs information that is used to instruct the recommendation of process definition, to the work request history management unit 94 (Process J12). The work request history management unit 94 executes processing in which a similar work request in the past is searched for, with reference to the work request history DB 60 (Process J13). When there is the similar work request, work request history management unit 94 transmits the information that is used to instruct the recommendation of process definition, to the process definition management unit 90 (Process J14). The process definition management unit 90 obtains process definition that corresponds to the work request that has been instructed from the work request history management unit 94 (Process J15). In addition, the process definition management unit 90 transmits the obtained information to the client device 66 as recommended process definition (Process J16). The client device 66 displays the information that has transmitted from the process definition management unit 90 on the display unit 76 so that the information is allowed to be selected (Process J17). The effecter may confirm the process definition of the similar work request, with reference to the display unit 76 (Process J18). When there is no similar work request, the processing proceeds to Process J24 (FIG. 13A).

The determination of a similar work request may be executed by the following degree of similarity calculation processing. First, a calculation expression of a degree of similarity sim between two work requests is represented.

$$sim ( r 1 , r 2 ) = cos ( rv 1 , rv 2 ) = \frac{rv 1 \cdot rv 2}{\vert rv 1 \vert \vert rv 2 \vert} \qquad ( 1 )$$

Here,

rn: Work request

rvn: Feature vector that is generated from the work request

cos (rv1,rv2): Cosine similarity of the feature vectors.

Based on the above-described mathematical expression, it is determined that the two work requests become similar as a value of “sim (r1,r2)” is closer to 1.

The definition of the feature vector rvn is described below.

For all work requests to a certain operation domain, a word is extracted from a request name, a request content, each item name of input information, and each item name of output information by morphological analysis.

An importance degree Vnm of a word wm in the request rn is defined by the following expression.

Vmn(wm,rn)=TF−IDF(wm,rn)

The feature vector rvn is a real vector using the importance degree of each word as an item.

$$\begin{matrix}{w}_{i , m} = {df}_{i , m} \times {imf}_{i} \\ = \frac{{n}_{i , m}}{{\sum }_{k} {n}_{k , m}} \times log ( \frac{\vert M \vert}{\vert \{ {L}_{m} : {L}_{m} ∋ i \} \vert} )\end{matrix} \qquad ( 2 )$$

Here,

TFmn: Proportion of the word wm to all words that are included in the request rn

IDFm: Indicator that indicates the generality of the word wm. The value becomes smaller as the words wm are included in more requests.

Nmn: Number of words wm that are included in the request rn

ΣkNkn: Total number of words that are included in the request rn

|D|: Number of requests

|{d: [symbol] wm}|: The number of requests that include the words wm.

On the other hand, when the client device 66 is operated in order to reject the take-on of the work request, and “No” is determined in Step 202, rejection processing of the work request is executed in Step 206. In addition, the processing returns to Step 200. That is, the effecter operates the client device 66, and the client device 66 transmits information that indicates an instruction of rejection of the work request, to the process engine unit 86 (Processes J19 and J20 illustrated in FIG. 12B) in order to reject the take-on of the work request. The process engine unit 86 executes the rejecting processing of the work request using the work item DB 58 and the work request history DB 60, in accordance with the instruction from the client device 66, and transmits information that indicates processing completion, to the client device 66 (Process 321). The client device 66 changes the state in the work item of the operation effect list 102 in the ToDo screen 100 from “take-on standby” to “rejection” based on the information that indicates processing completion, which has been received from the process engine unit 86, and displays the state on the display unit 76. The effecter may confirm that the work request is rejected, with reference to the display unit 76 (Process J22).

After that, in Step 212, in the computer system 11, determination processing of whether or not utilization of the recommended process definition is instructed is executed. When “Yes” is determined in Step 212, start processing of a workflow by the recommended process definition is executed in Step 220. In addition, the processing proceeds to Step 222. That is, the effecter determines whether or not process definition from among pieces of recommended process definition that have been displayed on the client device 66 is used (Process J23 illustrated in FIG. 13A), and operates the client device 66. When the client device 66 is operated in order to use the process definition (Process J34), the client device 66 outputs information that indicates an instruction of start of the workflow using the process definition, to the process engine unit 86 (Process J35). The process engine unit 86 starts the workflow using the work item DB 58 and the process definition DB 62 in accordance with the instruction from the client device 66 (Process J36).

On the other hand, the client device 66 is operated in order to start the workflow without using the recommended process definition. When “No” is determined in Step 212, determination processing is executed in which whether or not search processing of process definition to be utilized is executed in Step 214. On the other hand, when “Yes” is determined in Step 214, the search processing of process definition is executed in Step 216. That is, the effecter operates the client device 66 in order to search for the process definition to be utilized. In addition, the client device 66 transmits information that indicates the search instruction of the process definition, to the process definition management unit 90 (Processes J25 and 326 illustrated in FIG. 13A). The process definition management unit 90 executes the search processing of the process definition using the process definition DB 62 in accordance with the instruction from the client device 66. In addition, the process definition management unit 90 transmits the search result to the client device 66 (Process 327). The client device 66 displays the search result from the process definition management unit 90 on the display unit 76 (Process J28). The effecter confirms the search result with reference to the display unit 76 (Process J29), and determines whether or not the process definition that is included in the search result is utilized (Process J30). When the process definition is utilized, the stage transitions to a stage in which the workflow is started (Process J34). When the process definition is not utilized, the stage transitions to a stage in which process definition is created (Process J31).

When “No” is determined in Step 214, creation processing of process definition is executed in Step 218. That is, the effecter operates the client device 66 in order to create process definition. In addition, the client device 66 transmits information that indicates a creation instruction of process definition, to the process definition management unit 90 (Processes J31 and 332 illustrated in FIG. 13B). The process definition management unit 90 executes the creation processing of process definition using the process definition DB 62 in accordance with the instruction from the client device 66. In addition, the process definition management unit 90 transmits the search result to the client device 66 (Process J33). In the client device 66, the processing proceeds to start processing of a workflow, based on the information from the process definition management unit 90 (Process J35).

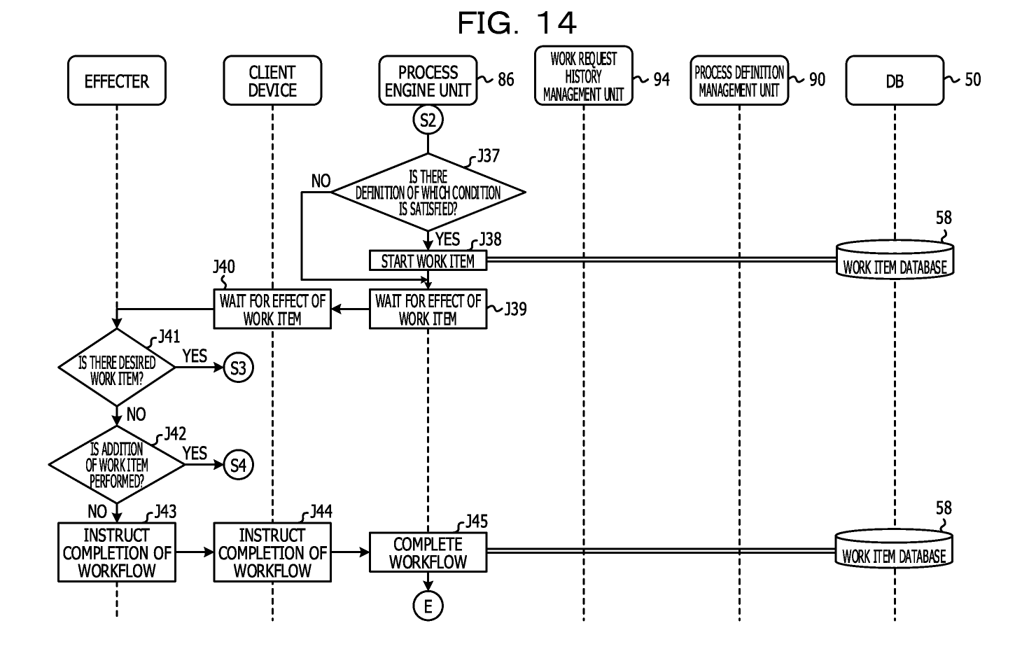

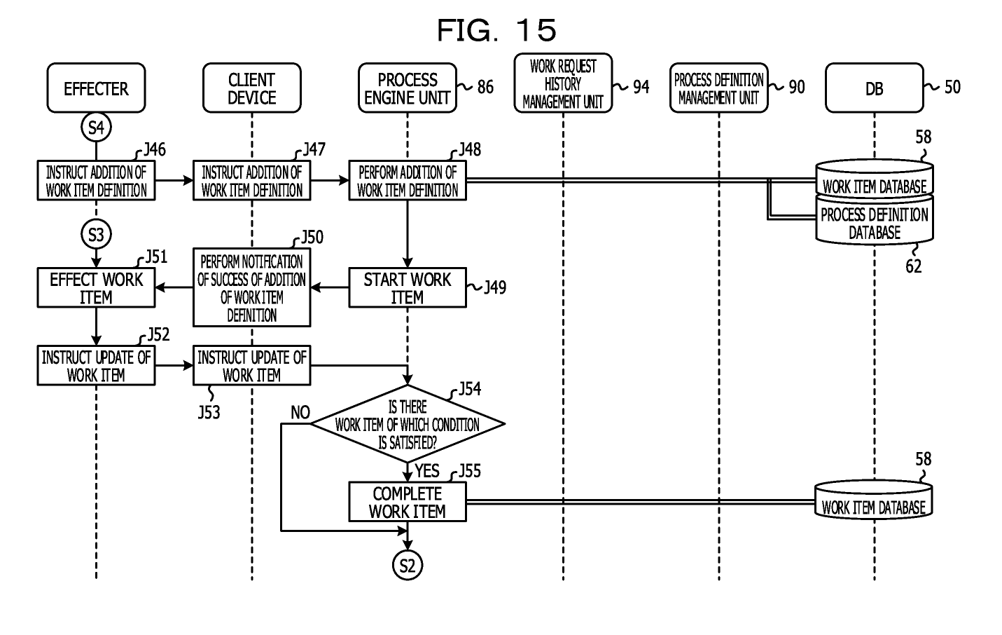

In the computer system 11, determination processing of whether or not work item definition that satisfies a start condition of the workflow exists is executed in Step 222 when the workflow is started. When “Yes” is determined in Step 222, the workflow by the work item that satisfies the start condition is started in Step 224. In addition, the processing proceeds to Step 226. On the other hand, when “No” is determined in Step 222, in the computer system 11, the processing proceeds to Step 226. That is, the process engine unit 86 determines whether or not work item definition that satisfies the start condition of the workflow exists (Process J37 illustrated in FIG. 14). When “Yes” is determined in Process J37, the work item that satisfies the start condition is started using the work item DB 58 (Process J38). On the other hand, when “No” is determined in Process J37, the process engine unit 86 waits for effect of the work item. In addition, the process engine unit 86 transmits information that indicates the effect standby of the work item, to the client device 66 (Process 339). The client device 66 displays the information from the process engine unit 86 on the display unit 76, and waits for the effect of the work item (Process J40).

After that, in Step 226, in the computer system 11, it is determined whether or not a work item to be effected exists. When “No” is determined in Step 226, it is determined whether or not addition processing of work item definition is executed in Step 228. When “No” is determined in Step 228, completion processing of the workflow is executed in Step 234. That is, when a work item to be effected does not exist, and the effecter does not desire addition of work item definition (“No” in both Processes J41 and J42 illustrated in FIG. 14), the effecter operates the client device 66 (Process J43). The client device 66 transmits information that indicates a completion instruction of the workflow, to the process engine unit 86 (Process J44). The process engine unit 86 executes the completion processing of the workflow using the work item DB 58 in accordance with the instruction from the client device 66 (Process J45).

On the other hand, when the addition processing of work item definition is executed “Yes” is determined in Step 228, the addition processing of work item definition in Step 230 is executed, and then start processing of the added work item is executed in Step 232. That is, when the effecter desires addition of work item definition as well (Process J46 illustrated in FIG. 15), the client device 66 transmits information that indicates an addition instruction of work item definition, to the process engine unit 86 (Process J47). The process engine unit 86 executes the addition processing of work item definition using the work item DB 58 and the process definition DB 62 in accordance with the instruction from the client device 66 (Process J48). After that, the process engine unit 86 transmits information that indicates that the work item has been started (success notification), to the client device 66 (Process J49). The client device 66 displays the information from the process engine unit 86 on the display unit 76 (Process J50). The effecter may effect the work item, with reference to the information that indicates the work item has been started (success notification) (Process J51).

When the work item to be effected exists (Yes is determined in Step 226), the work item is effected in Step 236 (the detail is described later), and the processing proceeds to Step 238. In Step 238, in the computer system 11, it is determined that a work item that satisfies a completion condition exists. When “No” is determined in Step 238, the processing returns to Step 222. When “Yes” is determined in Step 238, completion processing of the work item is executed in Step 240, and the processing proceeds to Step 242. In Step 242, in the computer system 11, it is determined whether or not the workflow is completed. When “No” is determined in Step 242, the processing returns to Step 222. On the other hand, when “Yes” is determined in Step 242, the processing ends. That is, the effecter operates the client device 66 in order to instruct the update of the work item (Process J52) after the effecter has effected the work item (Process J51 illustrated in FIG. 15). The client device 66 transmits information that indicates an update instruction of the work item, to the process engine unit 86 (Process J53). When a work item that satisfies the completion condition exists (“Yes” in Process J54), the process engine unit 86 executes completion processing of the work item using the work item DB 58 in accordance with the instruction from the client device 66 (Process J55).

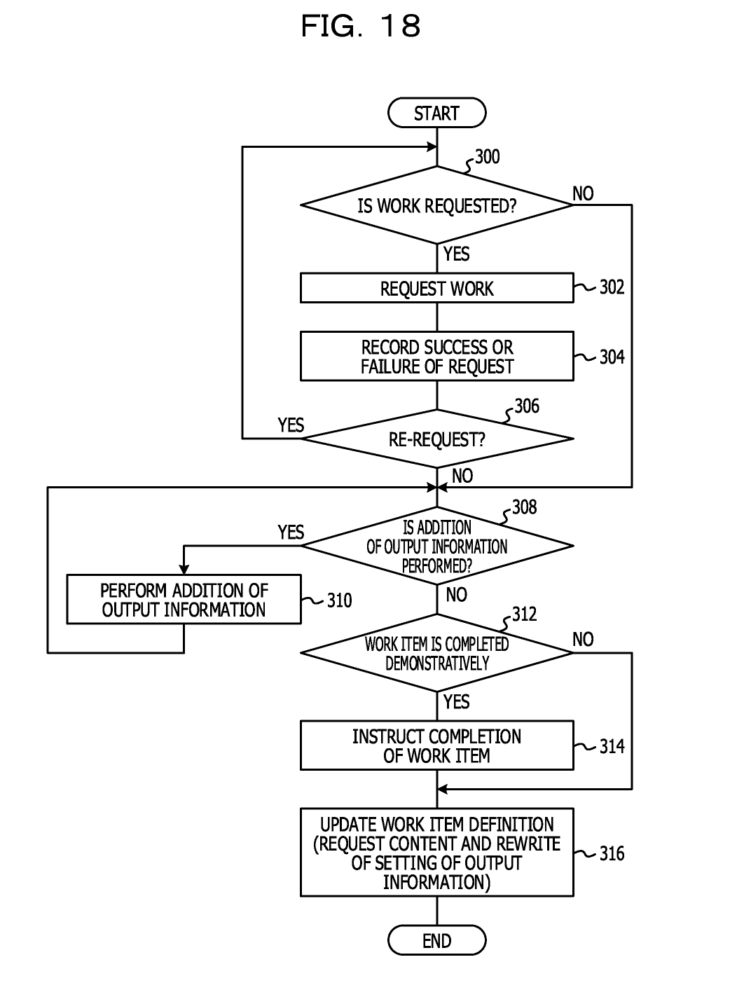

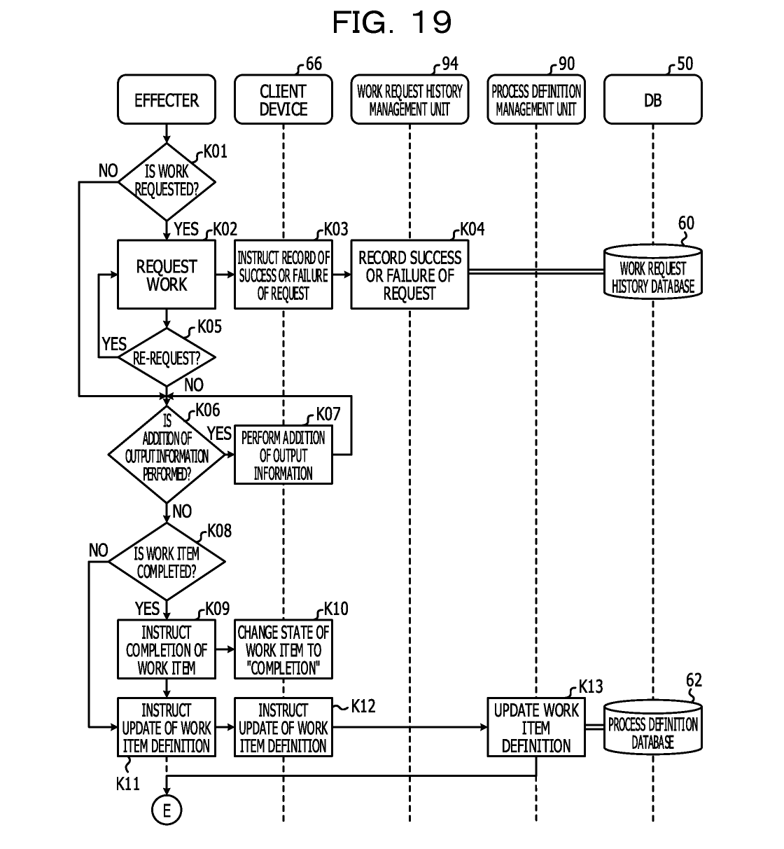

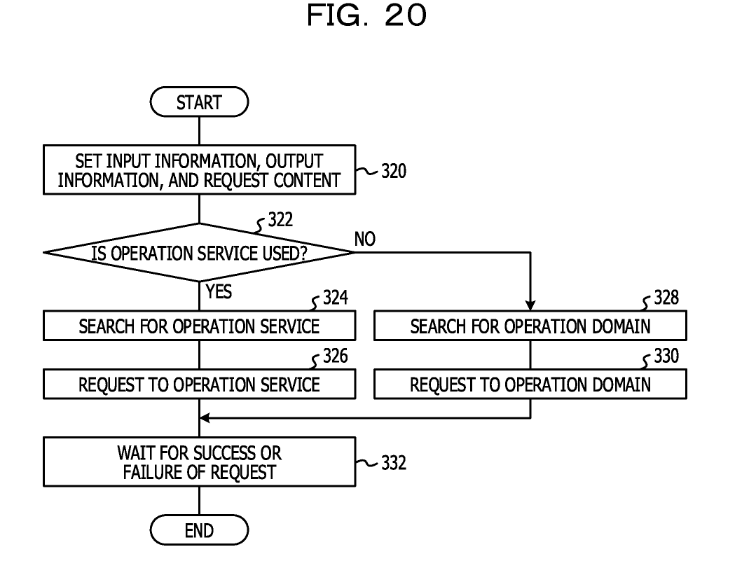

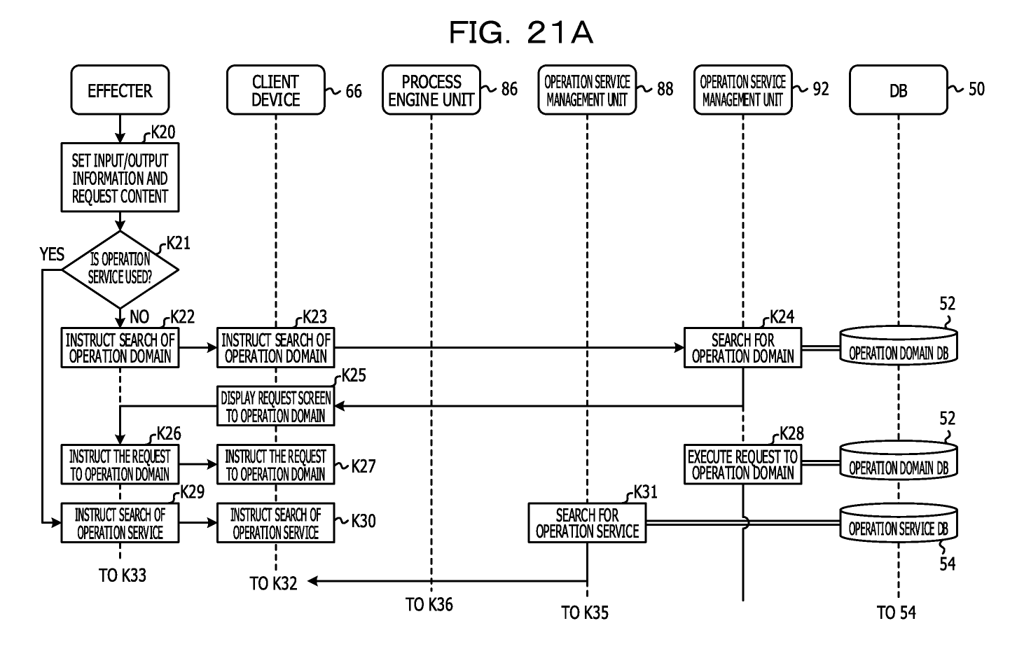

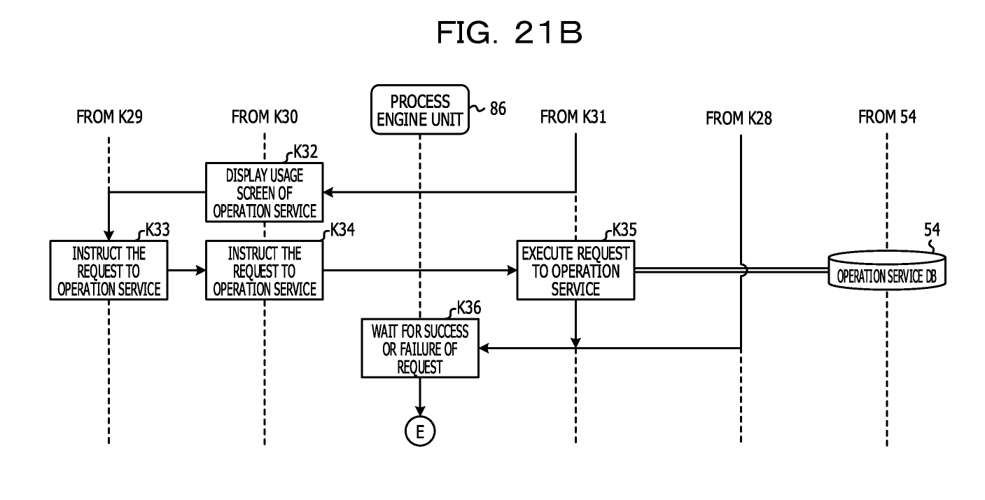

The processing of Step 236 illustrated in FIG. 11, which is executed in the computer system 11 (effect processing of a work item), is further described below. FIG. 18 illustrates an example of the effect processing of a work item. FIG. 19 illustrates a relationship between the client device 66 and the units in the server device 22 in accordance with a flow of the effect processing of a work item, as a sequence flow.

In the computer system 11, the effect processing of a work item illustrated in FIG. 18 is executed in the processing of Step 236 illustrated in FIG. 11. First, in Step 300, in the computer system 11, determination processing of whether or not a work is requested is executed. When “No” is determined in Step 300, the processing proceeds to Step 308. On the other hand, when “Yes” is determined in Step 300, request processing of the work in Step 302 is executed (the detail is described later), and record processing of the success or failure of the work request is executed in next Step 304. After that, in Step 306, determination processing of whether or not re-request of the work is executed is executed. When “Yes” is determined in Step 306, the processing returns to Step 300. On the other hand, when “No” is determined in Step 306, the processing proceeds to Step 308. That is, the effecter determines whether or not the work is requested (Process K01 illustrated in FIG. 19), and operates the client device 66 (Process K02) when the work is requested. The client device 66 outputs information that is used to instruct the record of the success or failure of the request, to the work request history management unit 94 (Process K03). The work request history management unit 94 records the success or failure of the request using the work request history DB 60 in accordance with the instruction from the client device 66 (Process K04). After the work is requested, the effecter determines whether or not the re-requested of the work is executed (Process K05), and the processing returns to Process K02 when the re-requested is performed.

In the record processing of the success or failure of the work request in Step 304, when both of a work item of the request source, and a process by process definition of the request destination are completed without failure, the success of the work request is recorded. In Step 304, work item definition that has been used in the request source, the process definition that has been used in the request destination, and a request distribution rule that has been used in the request destination are also recorded.

In Step 308, the computer system 11 executes determination processing of whether or not addition processing of output information is executed. When “Yes” is determined in Step 308, the processing returns to Step 308 after the addition processing of output information has been executed in Step 310. That is, the effecter determines whether or not the addition processing of output information is executed (Process K06 illustrated in FIG. 19), and operates the client device 66. The client device 66 displays the work effect screen 110 (FIG. 17), and executes the addition processing of output information that has been input (to the display area 112 of the work request tool illustrated in FIG. 17) by the effecter (Process K07).

After that, in Step 312, in the computer system 11, it is determined whether or not processing in which the work item demonstratively is completed is executed. When “Yes” is determined in Step 312, completion instruction processing of the work item is executed in Step 314, and the processing proceeds to Step 316. On the other hand, when “No” is determined in Step 312, the processing proceeds to Step 316. In Step 316, update processing of the work item definition is executed. That is, the effecter determines whether or not the work item is completed (Process K08 illustrated in FIG. 19), and operates the client device 66 in order to instruct the completion of the work item (Process K09). The client device 66 changes the state of the work item to “completion” in accordance with the instruction (Process K10). On the other hand, when the effecter determines that the work item is not completed (“No” in Process K08), the effecter operates the client device 66 in order to instruct the update of the work item definition (Process K11). The client device 66 transmits information that indicates an update instruction of the work item definition, to the process definition management unit 90 (Process K12). The process definition management unit 90 updates the work item definition using the process definition DB 62 in accordance with the instruction from the client device 66 (Process K13).

In the computer system 11, the work request processing illustrated in FIG. 20 is executed in the processing of Step 302 illustrated in FIG. 18. FIGS. 21A and 21B illustrates a relationship between the units in work request processing as a sequence flow. First, in Step 320, in the computer system 11, setting processing of input information, output information, and a request content is executed. After that, in Step 322, determination processing of whether or not operation service is used is executed. When “Yes” is determined in Step 322, request processing to the operation service is executed after search processing of the operation service in Step 324 has been executed. That is, the effecter sets input information, output information, and a request content (Process K20 illustrated in FIG. 21A), and determines whether or not the operation service is used (Process K21). When the operation service is used, the effecter operates the client device 66 in order to search for operation service (Process K29). The client device 66 outputs information that is used to instruct the search of operation service, to the operation service management unit 88 (Process K30). The operation service management unit 88 searches for the instructed operation service using the operation service DB 54 in accordance with the instruction from the client device 66. In addition, the operation service management unit 88 transmits the search result to the client device 66 (Process K31). The client device 66 displays the information that has been transmitted from the operation service management unit 88 on the display unit 76 so that the information is allowed to be selected (Process K32). That is, the client device 66 displays the information that has been transmitted from the operation service management unit 88, on an area of the search result in the operation search tool of the work effect screen 110, as an operation service utilization screen. The effecter confirms the operation service to be utilized, with reference to the display unit 76, and operates the client device 66 (Process K33). The client device 66 outputs information that is used to instruct the request to operation service, to the operation service management unit 88 (Process K34). The operation service management unit 88 executes a request to the instructed operation service using the operation service DB 54 in accordance with the instruction from the client device 66 (Process K35). The operation service management unit 88 outputs information that indicates that the request to the operation service has been executed, to the process engine unit 86. The process engine unit 86 waits for the success or failure of the instructed operation service (Process K36).

On the other hand, when “No” is determined in Step 322, request processing to an operation domain is executed in Step 330 after search processing of an operation domain has been executed in in Step 328. In Step 332, in the computer system 11, the processing is waited for until the request is succeeded or failed. That is, on the other hand, when operation service is not used, the effecter operates the client device 66 in order to search for the operation domain (Process K22). The client device 66 outputs information that is used to instruct the search of an operation domain, to the operation domain management unit 92 (Process K23). The operation domain management unit 92 searches for the instructed operation domain using the operation domain DB 52 in accordance with the instruction from the client device 66. In addition, the operation domain management unit 92 transmits the search result to the client device 66 (Process K24). The client device 66 displays the information that has been transmitted from the operation domain management unit 92 on the display unit 76 so that the information is allowed to be selected (Process K25). That is, the client device 66 displays the information that has been transmitted from the operation domain management unit 92, on the area of the search result in the operation search tool of the work effect screen 110, as a request screen to the operation domain. The effecter confirms the operation domain to be utilized, with reference to the display unit 76, and operates the client device 66 (Process K26). The client device 66 outputs information that is used to instruct the request to the operation domain, to the operation domain management unit 92 (Process K27). The operation domain management unit 92 executes the instructed request for the operation domain using the operation domain DB 52 in accordance with the instruction from the client device 66 (Process K28). The operation domain management unit 92 outputs information that indicates that the request to the operation domain has been executed, to the process engine unit 86. The process engine unit 86 waits for the success or failure of the instructed operation service (Process K36).

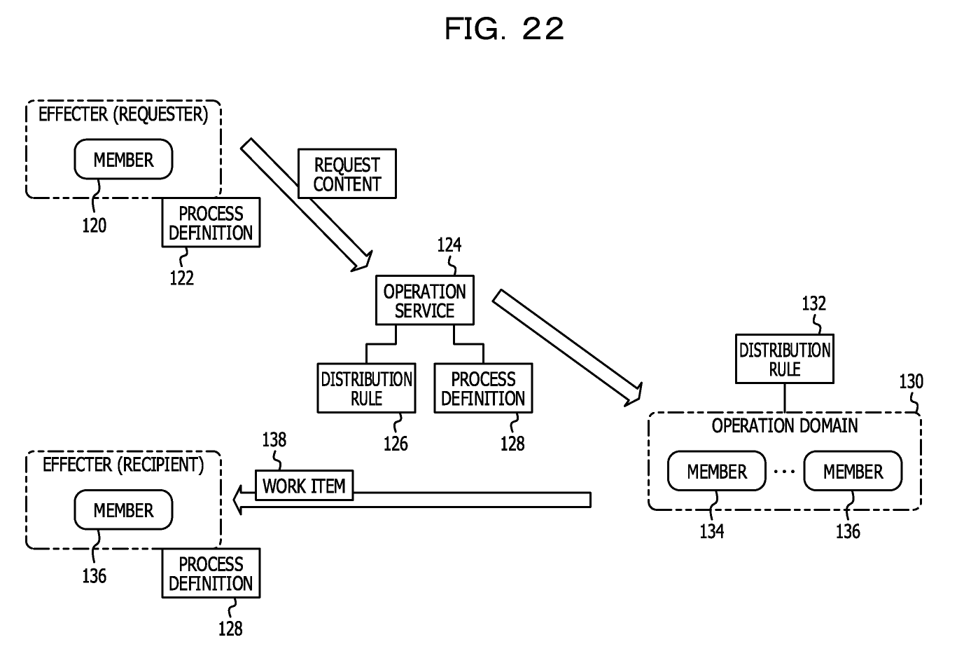

FIG. 22 illustrates an example of a flow of information that is related to a request to operation service. A member 120 who is an effecter (requester) of an operation of the request side adds new work item definition to process definition 122, and executes a work request to operation service 124. A distribution rule 126 and process definition 128 are associated with the operation service 124. For the request to the operation service 124, a recipient is set in accordance with the distribution rule 126. That is, an operation domain 130 that is to effect the operation service 124 is set to the operation service 124. In addition, a rule by which the request is distributed to members 134 and 136 that are registered to the operation domain 130 is set to the distribution rule 126. A distribution rule 132 for the operation domain 130 is associated with the operation domain 130. In FIG. 22, an example is illustrated in which the rule by which the request is distributed to a member 136 is set to the distribution rule 126. To the member 136, a work item 138 is requested in accordance with the process definition 128. The member 136 may select whether the request of the work item 138 is taken on or rejected. Thus, it is only sufficient for the request side to manage the process definition 122, and for the reception side to manage the process definition 128.

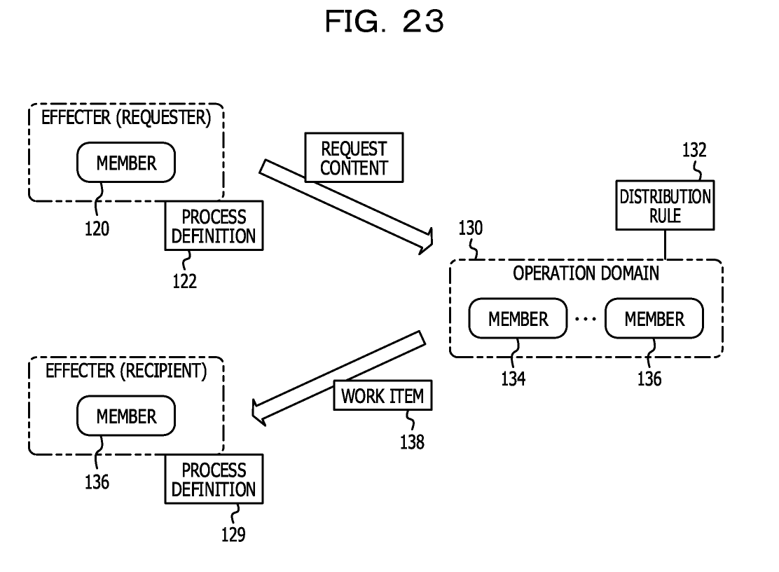

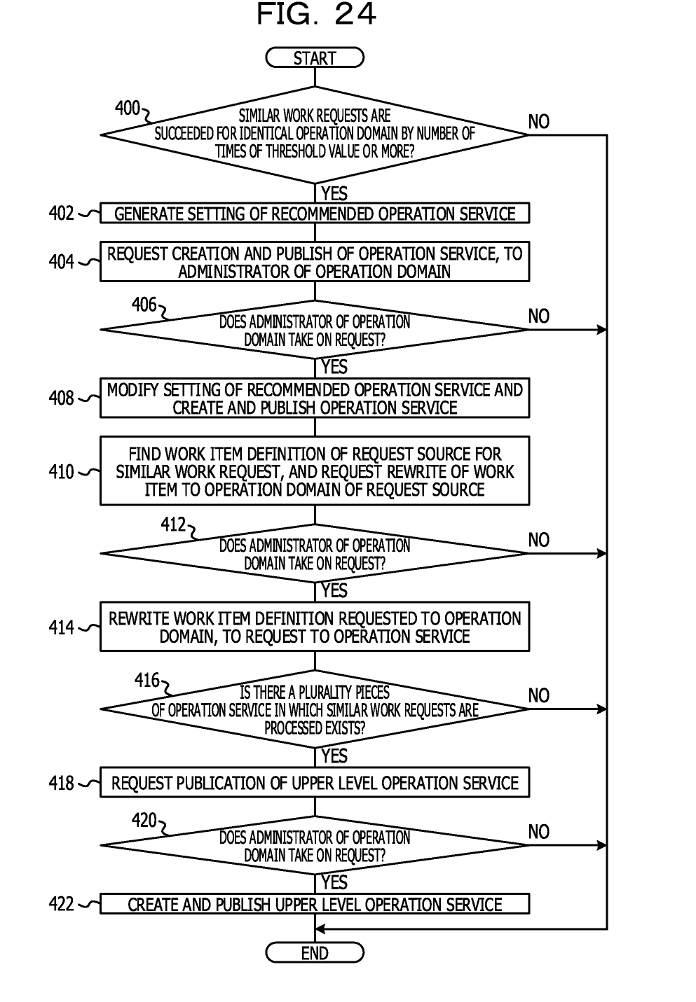

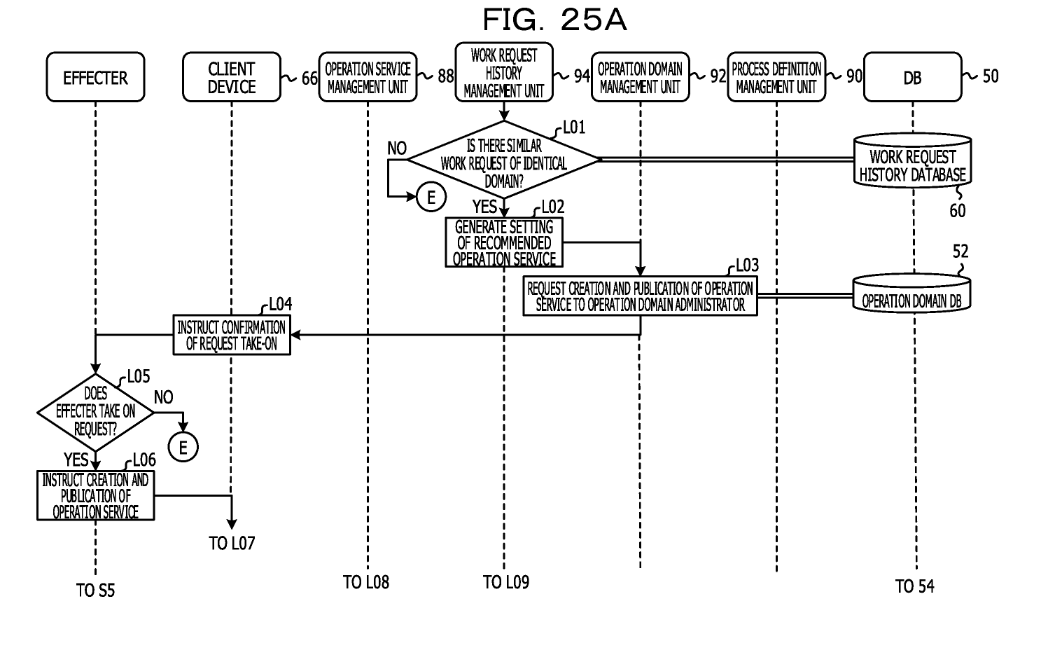

FIG. 23 illustrates an example of a flow of information that is related to a request to an operation domain. The member 120 that is an effecter (requester) of an operation of the request side adds new work item definition, to the process definition 122, and executes a work request to the operation domain 130. The distribution rule 132 is associated with the operation domain 130. For the request to the operation domain 130, a recipient is set in accordance with the distribution rule 132. For example, in accordance with the distribution rule 132 that is associated with the operation domain 130, the request is transferred to the member 136. In the member 136, process definition 129 is newly generated. In addition, the work item 138 is requested in accordance with the generated process definition 129. The member 136 may select whether the request of the work item 138 is taken on or rejected. Thus, it is only sufficient for the request side to manage the process definition 122 and for the reception side to manage the process definition 129.

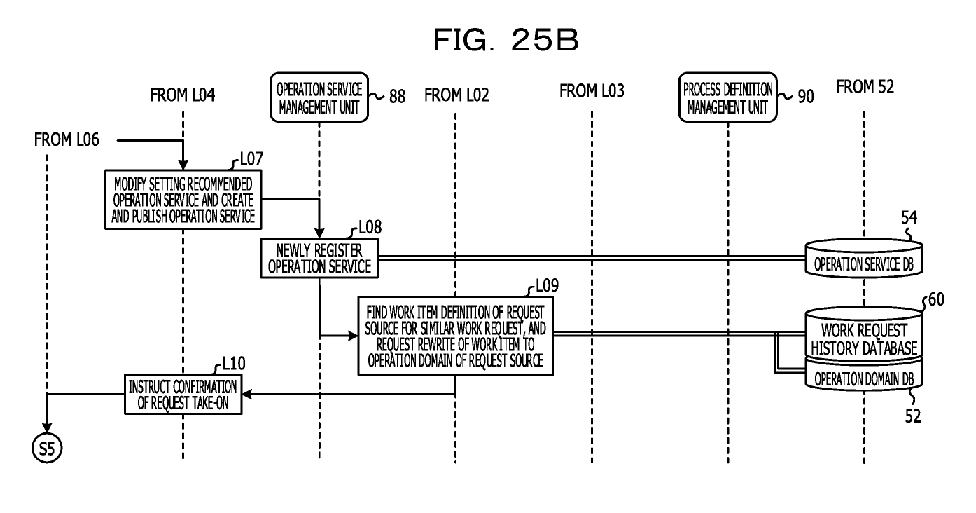

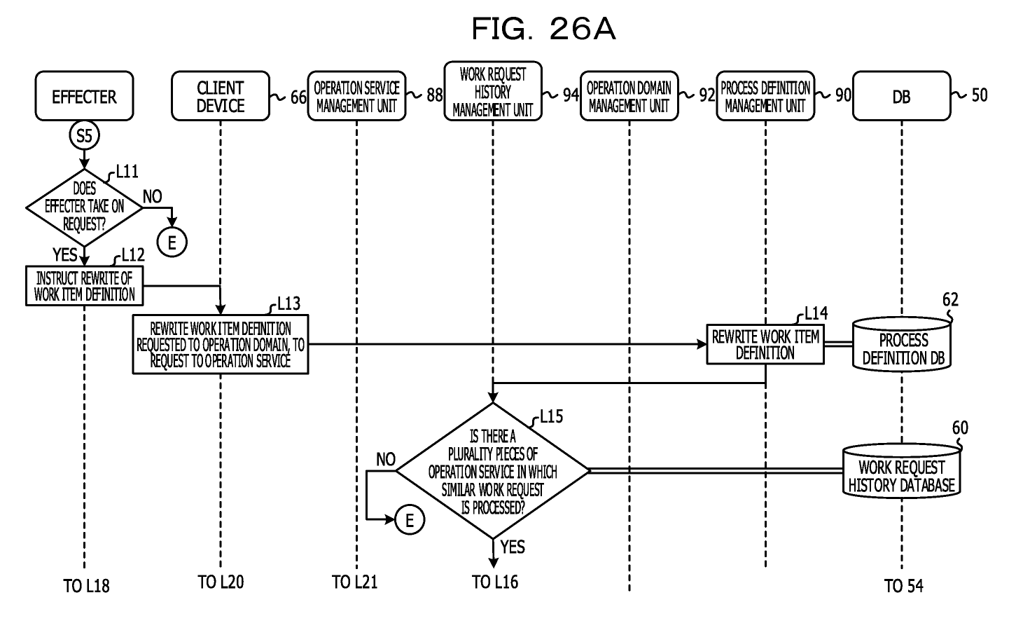

The suggestion of operation service by the computer system 11 is described below. FIG. 24 illustrates an example of a flow of suggestion processing of operation service. In each of FIGS. 25A, 25B, 26A and 26B, a relationship between the client device 66 and the units in the server device 22 that are related to suggestion of operation service is illustrated as a sequence flow. The suggestion processing of operation service illustrated in FIG. 24 is periodically executed in the computer system 11.

First, in Step 400, in the computer system 11, determination processing of whether or not a similar work request is succeeded for an identical operation domain by the number of times of the threshold value or more is executed. When “No” is determined in Step 400, the routine ends. On the other hand, when “Yes” is determined in Step 400, the processing proceeds to Step 402. That is, the work request history management unit 94 determines whether or not a similar work request that has been succeeded for an identical operation domain by the number of times of the threshold value or more exists, with reference to the work request history DB 60, (Process L01 illustrated in FIG. 25A). The work request history management unit 94 the ends processing when the similar work request is merely succeeded by less than the number of times of the threshold value.

“Yes” may be determined in Step 400 when a request rn that satisfies the following expression exists.

|{rₛ|sim(rₙ,rₛ)>simₜₕ}|>freqₜₕ (3)

Here,

rs: Request that is a target of degree of similarity comparison

sim (rn,rs): Degree of similarity between the requests rn and rs. The expression is described in the Mathematical expression 1

sim_th: Real number that is a threshold value that is used to determine whether or not the requests are similar. It is determined that the requests are sufficiently similar when the degree of similarity is larger than the value.

freq_th: Real number that is a threshold value that is used to determine whether or not the request occurs frequently. It is determined that the request occurs frequently when the number of similar requests is larger than the value.

When the similar work request has been succeeded by the number of times of the threshold value or more, in Step 402, in the computer system 11, setting of recommended operation service is generated. In addition, in next Step 404, a request of creation and publication of the operation service is executed for the administrator of the operation domain. That is, the work request history management unit 94 generates setting of the recommended operation service (Process L02), and instructs the request of creation and publication of the operation service from the operation domain management unit 92. The operation domain management unit 92 instructs the request of creation and publication of the operation service, to the administrator of the operation domain, using the operation domain DB 52 (Process L03). That is, the operation domain management unit 92 outputs information that indicates the request, to the client device 66 (management device 66C) of the administrator of the operation domain. The client device 66 (management device 66C) displays the information from the operation domain management unit 92, on the display unit 76. In addition, the client device 66 instructs the confirmation of the information to the administrator of the operation domain, who is the effecter (Process L04).

In the generation processing of setting of operation service in Step 402, the following conditions are applied. The first condition is that a request destination operation domain of a request rn is set as a publication location of operation service, and a request distribution rule that has been used in the request destination of the request rn is set as a request distribution rule of the operation service. The second condition is that a request source operation domain of a request rs is set as a publication range of the operation service. However, from among operation domains between which there is an ownership relationship, an operation domain that is occupied by the request source operation domain by a threshold value ratio that has determined beforehand or more may be included in the publication range. The third condition is that, by the process definition that has been used by the request destination for the request rn, input information of the initial work item definition is set as input information of setting of the operation service, and output information of the last work item definition is set as output information of setting of operation service, and the name of the process definition is set as the name of the operation service.

After that, in Step 406, in the computer system 11, it is determined whether or not the administrator of the operation domain has taken on the request. When “No” is determined in Step 406, the routine ends. On the other hand, when “Yes” is determined in Step 406, the processing proceeds to Step 408. In Step 408, processing is executed in which the setting of the recommended operation service is modifies, and the operation service is created and published. In next Step 410, processing is executed in which work item definition of the request source is found for a similar work request, and rewrite of the work item is requested to the operation domain of the request source. That is, the effecter determines whether or not the request that has been instructed from the operation domain management unit 92 is taken on (Process L05 illustrated in FIG. 25A). When the request that has been instructed from the operation domain management unit 92 is taken on, the client device 66 is operated in order to instruct the creation and publish of the operation service (Process L06). The client device 66 modifies setting of the recommended operation service in accordance with the instruction, and outputs information that indicates that the operation service is created and published, to the operation service management unit 88 (Process L07). The operation service management unit 88 executes processing in which the instructed operation service is newly registered to the operation service DB 54, and notifies the work request history management unit 94 of the registration (Process L08). The work request history management unit 94 finds work item definition of the request source for the similar work request, based on the notification from the operation service management unit 88, and outputs an instruction to request the rewrite of the work item from the operation domain that is the request source, to the client device 66 (Process L09). The client device 66 displays the information from the work request history management unit 94, on the display unit 76. In addition, the client device 66 instructs the confirmation of the information to the administrator of the operation domain that is the effecter (Process L10).

In Step 412, in the computer system 11, it is determined whether or not the administrator of the operation domain has been taken on the request. When “No” is determined in Step 412, the routine ends. On the other hand, when “Yes” is determined in Step 412, the processing proceeds to Step 414. In Step 414, instruction processing is executed in which the work item definition that has been requested to the operation domain is rewritten to a request to the operation service. That is, the effecter determines whether or not the request that has been instructed from the work request history management unit 94 is taken on (Process L11 illustrated in FIG. 26A). When the request that has been instructed from the work request history management unit 94 is taken on, the client device 66 is operated in order to instruct the rewrite of the work item definition (Process L12). The client device 66 outputs information that indicates the instruction of rewrite of the work item definition that has been requested to the operation domain, to the request to the operation service, to the process definition management unit 90, in accordance with the instruction (Process L13). The process definition management unit 90 executes the requested rewrite processing of the work item definition, for the process definition DB 62, and notifies the work request history management unit 94 of the rewrite (Process L14).

In addition, in Step 416, in the computer system 11, it is determined whether or not there is a plurality pieces of operation service in which similar work requests are processed. When “No” is determined in Step 416, the routine ends. On the other hand, when “Yes” is determined in Step 416, the processing proceeds to Step 418. In Step 418, instruction processing of a request of publication of upper level operation service is executed. That is, the work request history management unit 94 determines whether or not there is a plurality of pieces of operation service in which similar work requests are processed, with reference to the work request history DB 60, by the notification from the process definition management unit 90 (Process L15). When there is a plurality of pieces of operation service in which similar work requests are processed, the work request history management unit 94 outputs the instruction of request of publication of the upper level operation service, to the client device 66 (Process L16). The client device 66 displays the information from the work request history management unit 94, on the display unit 76. In addition, the client device 66 instructs the confirmation of the information to the administrator of the operation domain, who is the effecter (Process L17).

After that, in Step 420, in the computer system 11, it is determined whether or not the administrator of the operation domain has been taken on the request. When “No” is determined in Step 420, the routine ends. On the other hand, when “Yes” is determined in Step 420, the processing proceeds to Step 422. In Step 422, processing is executed in which the upper level operation service is created and published. That is, the effecter determines whether or not the request that has been instructed from the work request history management unit 94 is taken on (Process L18 illustrated in FIG. 26B). When the request that has been instructed from the work request history management unit 94 is taken on, the client device 66 is operated in order to request creation and publication of the upper level operation service (Process L19). The client device 66 outputs information that indicates creation and publication of the upper level operation service, to the operation service management unit 88, in accordance with the instruction (Process L20). The operation service management unit 88 executes processing in which the instructed upper level operation service is newly registered to the operation service DB 54 (Process L21).

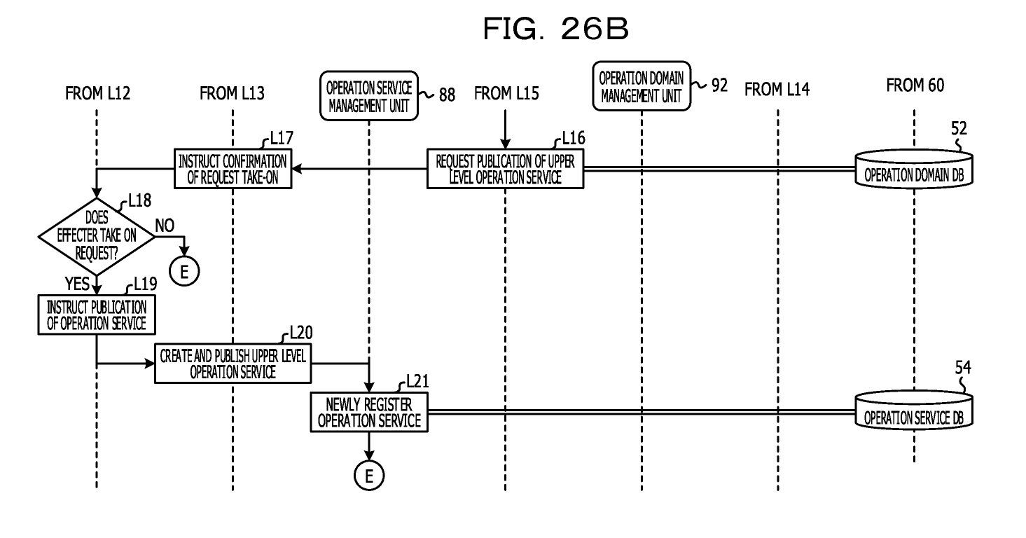

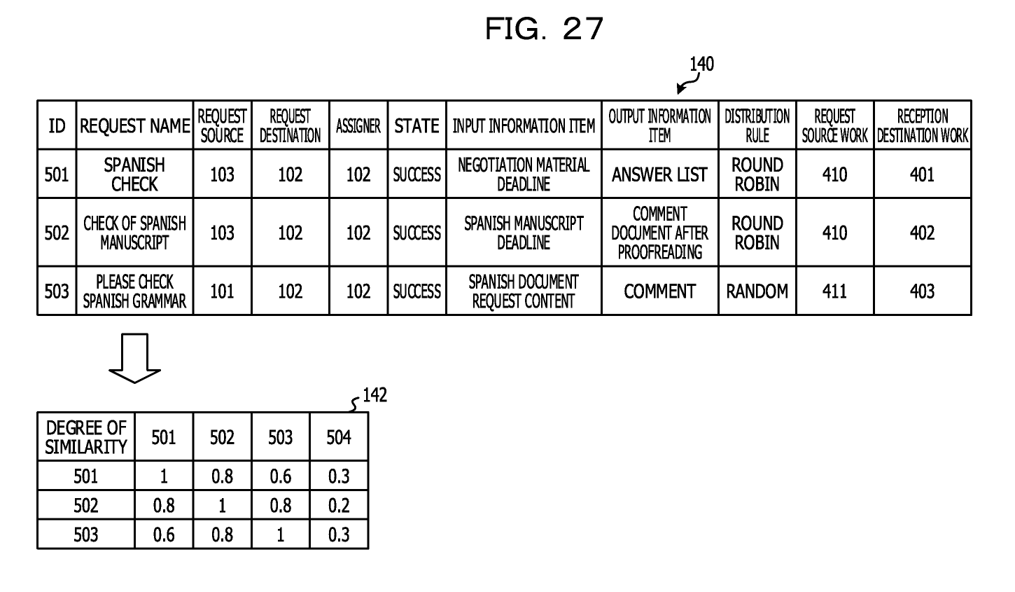

FIG. 27 illustrates an example of information that is used to identify operation service that is a suggestion target in the suggestion processing of operation service (FIG. 24). First, related information of a work request to which a similar work request has been succeeded by the number of times of the threshold value or more, and that has been executed for a certain operation domain directly is extracted from each of the DBs based on data of the work request history DB 60 to generate a table to be coupled externally. FIG. 27 illustrates a coupling table 140 as the table that has been coupled externally. Also, FIG. 27 illustrates a similarity table 142 that corresponds to the coupling table 140, and that is used to determine the similar work request that has been succeeded by the number of times of the threshold value or more. In the example illustrated in FIG. 27, the threshold value is set at 0.5, a request history of an ID 502 in which a total of degrees of similarity with the other request histories is the largest is represented.

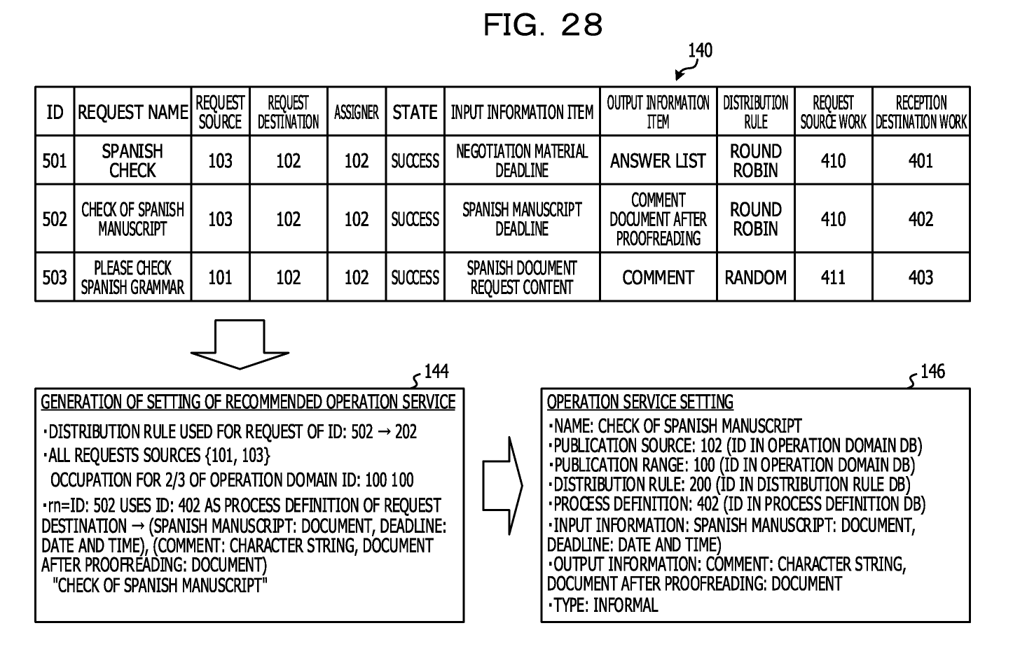

FIG. 28 illustrates an example of information that is used to generate setting of operation service in the suggestion processing of operation service (FIG. 24). First, setting of recommended operation service is generated from the coupling table 140 (FIG. 27) that has been generated based on data of the work request history DB 60. FIG. 28 illustrates information 144 that indicates setting of recommended operation service. In the information 144, when the request of the ID 502 is a target, a distribution rule is “200”. All of request sources are “101 and 103”, and occupies ⅔ of members that are included in the ID 100 of the operation domain. Therefore, the operation domain is the ID 100. In addition, in “request rn=the ID 502”, an ID 402 is used as process definition of the request destination. That is, the input information is “spanish manuscript: document, and deadline: date and time”, and the output information is “comment: character string, and document after proofreading: document”, and the name is “check the spanish manuscript”. After that, information 146 that is used to set operation service is generated from the information 144. The information 146 that is used to set operation service includes information in which the name is “check a spanish manuscript”, information in which the publication source is “102 (ID in the operation domain DB 52)”, and the publication range is “100 (ID in the operation domain DB 52)”. The information 146 includes information in which the distribution rule is “200 (ID in the distribution rule DB 56)”, and information in which the process definition is “402 (ID in the process definition DB 62)”. In addition, the information 146 incudes information in which the input information is “spanish manuscript: document, and deadline: date and time”, information in which the output information is “comment: character string, and document after proofreading: document”, and information in which the type is “informal”.

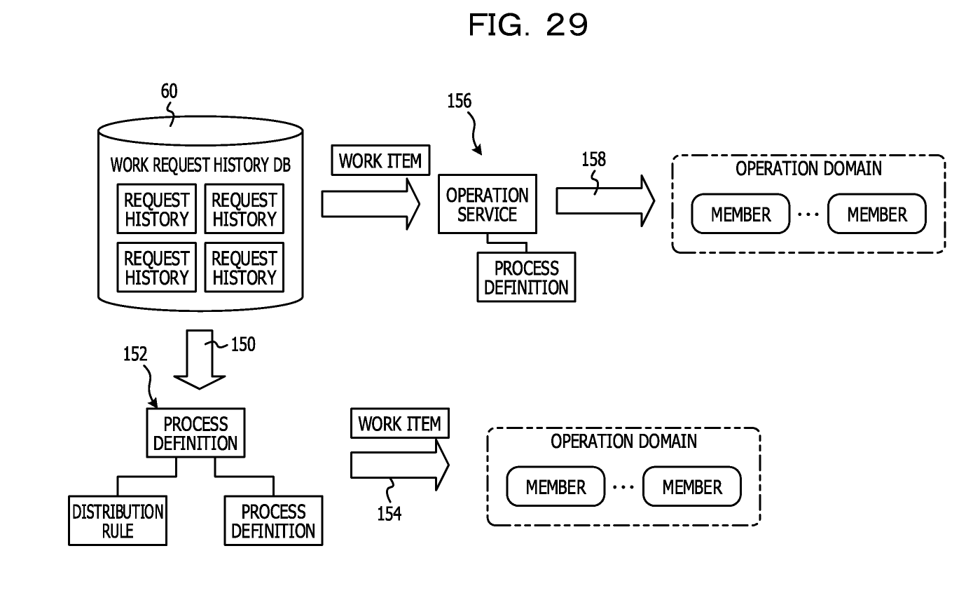

FIG. 29 illustrates an example of a flow of information that is related to creation and suggestion of operation service. First, processing 150 is executed in which operation service setting 152 to which it is predicted that a similar request is executed is generated, by analyzing the work request history DB 60. The generated operation service setting 152 is suggested to the administrator of the operation domain by processing 154. When the suggestion by the processing 154 is taken on by the administrator of the operation domain, new operation service is published. A request history that is similar to the request history that is a source of certain operation service is identified by analyzing the work request history DB 60. Processing 158 is executed in which utilization of operation service 156 is suggested to the administrator of the operation service that is registered to process definition that is included in the identified request history. As a result, an increase in pieces of operation service may be suppressed.

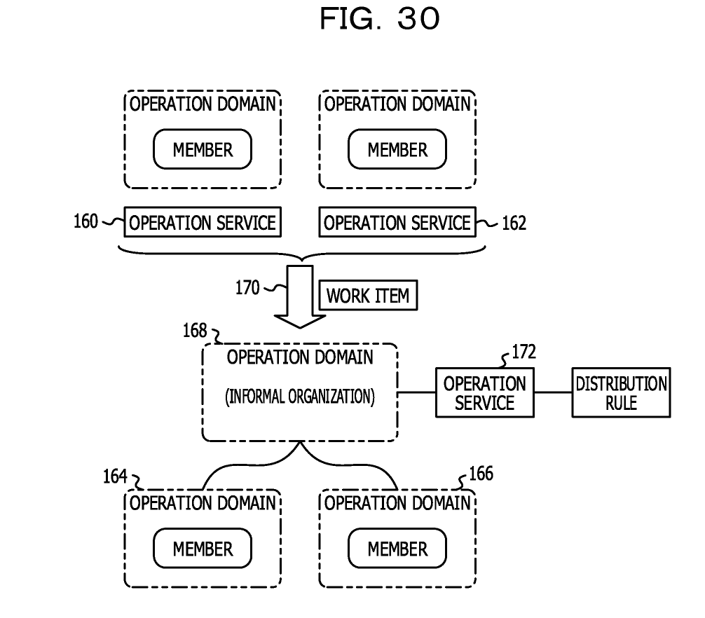

FIG. 30 illustrates an example of a flow of information that is related to suggestion of integration of operation service. First, pieces of operation service 160 and 162 that receive similar requests are identified by analyzing the work request history DB 60. After that, processing 170 is executed in which an upper level operation domain 168 is created newly for a plurality of operation domains 164 and 166 in which the identified pieces of operation service 160 and 162 are published, and publication of operation service 172 that is a general conduit is suggested. As described above, cooperation of members between the operation domains may be achieved by generating operation service that covers all of the plurality of pieces of operation service that receive the similar requests.

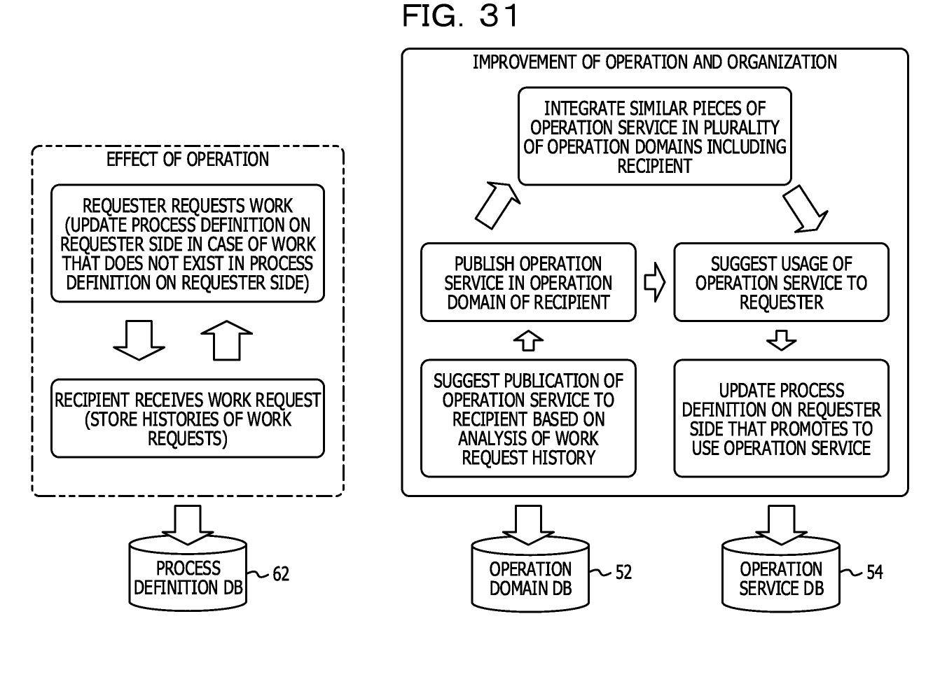

FIG. 31 illustrates an example of a flow of continual information in the computer system 11. The computer system 11 according to the embodiment contributes to the effect of an operation and the improvement of the operation and an organization. That is, in the effect of the operation, a request of a work by a requester and reception of the work request by a recipient are repeated. That is, in the effect of the operation, addition or update of process definition is performed by repeating the request, reception, and effect. Thus, a workflow may be operated by process definition by a slight description, using the operation service. In terms of the operation and organization, suggestion of publication of operation service, publication of the suggested operation service, integration of the pieces of operation service, utilization of the operation service, and update of the process definition are executed independently of each other. Thus, in the improvement of the operation and organization, based on analysis of a history of the operation, description for a request is suppressed, and operation service may be constructed in an organized manner so as to contribute to efficient request, reception, and effect.

As described above, in the embodiment, using operation service as a boundary, pieces of information that are empirically obtained in the requester side and the recipient side are formalized. Therefore, the requester side may create process definition without considering the state of the recipient side. In addition, it is only sufficient for the recipient side to consider the state of the recipient side and manage a rule, so that complication of the management may be suppressed. Even when the state of the recipient side is changed, the pieces of process definition of the requester side may be maintained, and an increase in the maintenance man-hour may be suppressed as long as input/output data of the operation service is not changed.

When existing operation service is used on the recipient side, the man-hour that is desired to maintain pieces of process definition is increased with an increase in the pieces of process definition that includes similar work items. Even in a case of similar requests, man-hour that is desired to effect the request is increased in order to handle with each of the requests individually. In the embodiment, by using the existing operation service on the recipient side, the man-hour that is desired to effect the pieces of process definition is suppressed, and man-hour of the effect of a request is suppressed. That is, the process definition of the requester side is not affected by a content of effect of the operation service that. On the other hand, on the recipient side, a request is executed that is unified in a format of a request that corresponds to information that is empirically obtained.

In addition, in the embodiment, process definition that is obtained by formalizing an identical work or similar works in the request side and the reception side is generated. In the method, an increase in pieces of process definition may be suppressed.

In addition, in the embodiment, as operation service, information that is input or output in each of the request side and the reception side is defined independently. In the method, process definition of each of the request side and the reception side may be managed independently.

In the embodiment, an operation domain that indicates a set of workers is associated with operation service. In the method, process definition may be managed in a unit of an organization.

In the embodiment, a distribution rule by which a request is distributed is associated with operation service. In the method, a request may be executed rapidly in accordance with the distribution rule.

In addition, in the embodiment, a request history of an operation based on a request, in which the effect of the request has been succeeded is stored. In the method, a valid request history in which the effect of the request has been succeeded may be utilized.

In addition, in the embodiment, operation service that is related on a similar operation is suggested based on a request history. In the method, operation service that is predicted to be continuously used may be employed in high precision.

In the embodiment, upper level operation service is generated and suggested for a plurality of pieces of operation service. In the method, users of the operation service may be increased.

The example is described above in which the operation formalization device 10 is obtained by the server device 22. However, the embodiments are not limited to these configurations, and various modifications and changes may be made without departing from the scope of the above description.

The example is described above in which a program is stored (installed) in a storage unit beforehand, but the embodiments are not limited to such an example. For example, the program in the technology discussed herein may be provided so as to be recorded to a recording medium such as a CD-ROM and a DVD-ROM.

All documents, patent applications, and technical standards listed in this specification are incorporated herein by reference, to the same extent as if the individual documents, patent applications, and technical standards are incorporated by reference is described specifically and individually.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing method that is executed by a processor included in an information processing device, the information processing method comprising:
obtaining request histories that respectively correspond to a plurality of operations, each of the plurality of operations including a plurality of works and each of the plurality of operations being executed based on a work request;
extracting one or more request side works related to a request side of each of the plurality of operations, from among the plurality of works, based on the request histories; and
generating process definition indicating definition of formalization of a process included in the one or more request side works.

2. The information processing method according to claim 1, further comprising:
extracting one or more reception side works related to a reception side of each of the plurality of operations, from among the plurality of works; and
generating process definition indicating definition of formalization of a process included in the one or more reception side works.

3. The information processing method according to claim 2, further comprising:
generating operation service information that includes a content of each of the plurality of operations and indicates a relationship between the one or more request side works and the one or more reception side works, based on the request histories; and
publishing the operation service information to an operation domain that indicates a set of workers who performs at least one of a work related to the work request and a work related to effect of the operation, which are included in the operation service information.

4. The information processing method according to claim 1, further comprising:
receiving the work request;
extracting a work request that is similar to the received work request, from the request histories; and
outputting the generated process definition correspondingly to the extracted work request.

5. The information processing method according to claim 4,
wherein the extracting of the work request that is similar to the received work request includes determining a degree of similarity to the work request that is included in the request histories, and determining that the work request that is included in the request histories is similar to the received work request when the degree of similarity is a certain threshold value or more.

6. The information processing method according to claim 3, further comprising:
generating an upper level operation domain that is an operation domain into which a plurality of operation domains that respectively correspond to a plurality of pieces of operation service information in which the similar work requests are processed are integrated when the plurality of pieces of operation service information exists;
generating upper level operation service information that is operation service information corresponding to the upper level operation domain, based on the plurality of pieces of operation service information; and
publishing the upper level operation service information to the upper level operation domain.

7. An information processing device, comprising:
a memory; and
a processor coupled to the memory and configured to:
obtain request histories that respectively correspond to a plurality of operations, each of the plurality of operations including a plurality of works and each of the plurality of operations being executed based on a work request;
extract one or more request side works related to a request side of each of the plurality of operations, from among the plurality of works, based on the request histories; and
generate process definition indicating definition of formalization of a process included in the one or more request side works.

8. The information processing device according to claim 7, wherein the processor is further configured to:
extract an one or more reception side works related to effect of the operation, from among the plurality of works, and
generate process definition indicating definition of formalization of a process included in the one or more reception side works.

9. The information processing device according to claim 8, wherein the processor is further configured to:
generate operation service information that includes a content of each of the plurality of operations and defines a relationship between the one or more request side works and the one or more reception side works, based on the request histories, and
publish the operation service information to an operation domain that indicates a set of workers who performs at least one of a work related to the work request and a work related to effect of the operation, which are included in the operation service information.

10. The information processing device according to claim 9,
wherein the operation service information includes information that is transmitted between the one or more request side works and the one or more reception side works.

11. The information processing device according to claim 9,
wherein the operation service information includes a distribution rule by which a request of the operation is distributed to one of a worker who effects a requested work of the operation and the operation domain.

12. The information processing device according to claim 7,
wherein the request histories include a record of a request that is related to an operation in which the effect of the request is succeeded.

13. A non-transitory computer-readable recording medium storing a program that causes a processor to execute a process, the process comprising:
obtaining request histories that respectively correspond to a plurality of operations, each of the plurality of operations including a plurality of works and each of the plurality of operations being executed based on a work request;
extracting one or more request side works related to a request side of each of the plurality of operations, from among the plurality of works, based on the request histories; and
generating process definition indicating definition of formalization of a process included in the one or more request side works.
